(19) United States
(12) Patent Application Publication
(10) Pub. No.: US 2009/0265723 A1
(43) Pub. Date: Oct. 22, 2009

(54) ELECTRONIC DEVICE AND CONTROL METHOD OF THE SAME

(76) Inventors: Hisayasu Mochizuki, Chiba (JP); Daiki Ogasawara, Chiba (JP)

Correspondence Address: BIRCH STEWART KOLASCH & BIRCH, PO BOX 747, FALLS CHURCH, VA, 22040-0747, US

(21) Appl. No.: 12/439,469

(22) PCT Filed: Aug. 29, 2007
(86) PCT No.: PCT/JP2007/066719

§ 371 Date: Feb. 27, 2009

(30) Foreign Application Priority Data
Aug. 31, 2006 (JP) 2006-235104
Aug. 31, 2006 (JP) 2006-235304

(51) Int. Cl. G06F 9/46; G06F 9/54

(52) U.S. Cl. 719/328; 718/102

(57) ABSTRACT

An electronic apparatus is provided with a system 1 and a main body section 3. The main body section 3 is provided with a conventional application management section 17 and conventional applications (CURRENT-A) 11, (CURRENT-B) 15. Furthermore, the main body section is provided with resources of graphic 31, working memory region (RAM) 21, sound reproduction 25, communication 21, nonvolatile RAM 27 and the like, as hardware resources necessary for implementing a function in a hardware that implements a certain function. In addition, the main body section 3 is provided with a new application management section 35 that manages a new application NEW-A 33, and performs resource switching between the new application management section 35 and that the conventional application management section 17 for all the hardware. Thus, an electronic apparatus having high expandability is provided.

### TECHNICAL FIELD

The present invention relates to an electronic apparatus, and in particular relates to a hardware control technique when new hardware is added.

### BACKGROUND ART

With the rapid development in technologies in recent years, there is a strong demand for products with high performance and multifunctionality.

Furthermore, due to an improvement in development speed of new technologies, new functions are being developed one after another. Here, in mounting the new functions, it is important to ensure consistency with conventional functions.

FIG. 2 is a view showing a configuration example of an ordinary electronic apparatus 401. The electronic apparatus 401 shown in FIG. 2 includes as the hardware, for example, a communication section 413, a RAM 415, a sound reproduction section 417, a nonvolatile RAM section 421, and a graphic section 423. Moreover, APP-A 403 and APP-B 405 are installed as the applications in the electronic apparatus 401. These applications operate the hardware while being alternatively switched by an application management section 407 (through application switching 411 and resource switching 425). That is, the electronic apparatus is comprehensively managed by the application management section 407, and is also integrated with an operation system.

In the electronic apparatus with the above-described configuration, system resources or hardware resources including the memories are allocated to the activated applications 403, 405.

For example, when the electronic apparatus is a mobile phone, the application management section 407 switches the applications, such as a telephone function, an e-mail, and a game, and controls the hardware, such as the RAM 415 and the graphic section 423.

Here, a problem often arises that even a subtle change in a specific module may adversely affect the whole system behavior, so that the whole design of the electronic apparatus should be reexamined even with a minor change. For example, when an application is added, a method of accessing hardware is necessarily added or reconfigured for each new application.

In the example of a mobile phone, whenever a new application, such as a camera or a web browser, is added, the application management section 407 should be modified in a way that the method of accessing the hardware, such as the RAM 415 or the graphic section 423, is redesigned.

To address this problem, in the invention disclosed in JPA 2006-65811, a system resource manager is provided to comprehensively manage resource managers each managing hardware or software, thereby facilitating cooperation with, control on, and management of the conventional functions even when a new function is added.

Patent Document 1: JPA 2006-65811

### DISCLOSURE OF THE INVENTION

### Problems to be Solved by the Invention

The above-described prior art is effective in a case where multiple applications can access the hardware arbitrarily. For example, in a case where a resource management section is built up in a system section, all the applications are equivalent, so that any application can access the hardware under this resource management.

However, due to the hardware constraints, multiple applications may not access the hardware in the following cases.

1) a case where a hardware initialization processing cannot be performed by multiple applications,

and

2) a case where the subsequent control is possible only from an application which has performed the hardware initialization.

The example of this is a case where only one application performs hardware control in order to maintain the state of hardware which has been changed by the past operation of a user, for the purpose of a high-speed operation of the hardware.

On the other hand, in particular in the development of an embedded apparatus, when the purposes are:
to minimize the function provided in the system as much as possible in order to improve the stability of the system, and
to reduce the portions depending on the hardware to be used as much as possible so as to improve the portability,

the hardware control is sometimes performed by an application featuring the electronic apparatus (an application necessary for forming the “mobile phone” in the general concept, such as a call phone function or the like in the case where the electronic apparatus is a mobile phone for example, and hereafter, such an application is referred to as a common application). This becomes remarkable when the hardware for implementing this featuring function is frequently modified in response to the technology advancement, a cost reduction request, and the like.

In this case, when adding a new application, exclusive control on access to hardware is performed by an application management section for managing the above-described common application (hereafter, this application management section is referred to as a conventional application management section for the purpose of the comparison with a new application management section for managing a newly added application). However, if the prior art is applied to the above-described system in which access to hardware from multiple applications is difficult, the exclusive control on access to the hardware becomes more complicated as the more applications are added. As a result, a problem arises that in the hardware implementing a certain function, the exclusive control should be finely performed on the hardware resources (such as the graphic, sound, nonvolatile RAM, communication, and RAM region) necessary for implementing the function.

FIG. 27 is a schematic view showing the above-described problem concerning the exclusive control on resources. The upper left view of FIG. 27 shows an application management, and shows a situation how n applications from A to N as conventional applications 431 are managed by a conventional application management section 433. If state transition from the conventional application A to the conventional application B is taken place, the setting of the resource in the exclusive control is changed with the change of the application mainly using the resource.

As a result, a total number of setting changes of the exclusive control in the conventional applications is as shown in the upper right of FIG. 28, and this number is n²−n.

Here, as shown in the lower left view of FIG. 27, if m applications from NEW-A to NEW-M are added as new applications (NEW) 435, a total number of setting changes of the exclusive control required after the state transition is as shown in the lower right view of FIG. 27, and this number is given by

(n+m)²−(n+m)=n²+2nm+m²−n−m

Consequently, an increased number of times in the setting changes of the exclusive control in response to the addition of the new applications is, as shown in the shaded portion in lower-right of FIG. 27, given by

(n²+2nm+m²−n−m)−(n²−n)=m²−m+2 mn=m(m+2n−1) (a),

where the above-described total number increases as the number n of the conventional applications and the number m of the new applications increase.

In this way, the addition of applications to an electronic apparatus in which many applications already exist significantly increase the number of setting changes of the exclusive control which are required due to transition, resulting in a large burden as an increase in the man-hours during development.

Furthermore, assume a case where a system, such as Linux or the like, which uses a virtual address for memory access is used. In this case, the memory access in the system or application is performed through a virtual address, whereas the memory access during hardware or firmware control should be performed using an actual physical memory. At this time, the virtual address needs to be translated to a physical address.

Here, processes other than the setting process cannot know the value of this physical address and thus cannot control the hardware nor the firmware. In such a case, an additional problem arises that the hardware control becomes difficult even if a different process separated from the conventional process is added in order to improve the development speed, the portability of a new function, or the like.

For example, in FIG. 2, even if a process which runs on a different process from the process shown in the drawing is newly added and an application which runs on this process is added, it is impossible to access the RAM or the graphic unless a special mechanism is prepared in the application management section 407, thus causing a problem that the new function cannot be executed.

Moreover, if a special mechanism for adding a different process is prepared in the application management section 407, development or test should be done while avoiding the load of the cost and time from being increased.

In order to do this, as previously described, it is necessary to

1) minimize the function provided in the system as much as possible in order to improve the stability of the system, and

2) reduce the portions depending on the hardware to be used as much as possible so as to improve the portability.

It is an object of the present invention to provide a stable and highly expandable electronic apparatus, while solving the above-described problems occurring in adding a new application, using the conventional system, and suppressing an increase in the man-hours of development and test.

### Means for Solving the Problems

According to the present invention, a new application management section (for convenience, a “first new application management section” described in claims is referred to as the new application management section) having the following functions is introduced in a common application.

1) a function of converting a function (processing content) desired to be executed and parameters and the like required for processing, which are received by inter-process communication, and performing hardware control by proxy (a different-process communication section, an API conversion section, a resource management section),

2) a function of notifying the applications other than the common application of information necessary for translating a virtual address to a physical address or a physical address to a virtual address by use of inter-process communication (the different-process communication section, the API conversion section, the resource management section), and

3) a function of performing exclusive control to avoid the occurrence of the simultaneous control on certain hardware (the resource management section, an exclusive control section). For example, when a graphic library is used, inter-process communication is performed between a new application and the new application management section (L3 in FIG. 1) to transfer the processing contents, such as filling a graphic plane, transfer, screen update, and the like, and also transfer the address of data required for the processing (L4 in FIG. 1).

Based on the transferred information, in the new application management section, the function to which exclusive control is added is used in the API provided by firmware to avoid multiple processings from being simultaneously performed. Also for other resources (sound reproduction, communication) and the like other than the graphic library, a similar proxy processing is performed. Thus, it is possible to access hardware from a process other than the common application.

Here, the exclusive control when the new application management section is added is described with reference to FIG. 28 to FIG. 31.

FIG. 28 is a view showing a configuration example when a conventional application management section 333 manages a conventional application A (331-1) to a conventional application N (331-n).

In contrast, in the present invention, as shown in FIG. 30, when m applications NEW-A to NEW-M are added as new applications (NEW) 335, the conventional application section 333 manages the n applications A to N as conventional applications 331 as well as a new application management section 337.

On the other hand, the new application management section 337 has a layered configuration for managing the m applications NEW-A to NEW-M as the new applications (NEW) 335.

Accordingly, with state transition, the new application management section performs setting changes of exclusive control corresponding to a shaded region 365 as shown in FIG. 31(A), whereas the conventional application management section performs setting changes of exclusive control corresponding to a shaded region 365 as shown in FIG. 31(B).

A total number of (B) is given by

(n+1)²−(n+1)=n²+2n+1−n−1=n²+n

An increase in exclusive control with the addition of a total number of (A): m²−m is given by

(n²+n)+(m²−m)−(n²−n)=m²−m+2n (b).

This reveals that an increase in the setting changes of exclusive control in the case where the new application management section is used is less by 2n(m−1), which is a difference between Equation (b) and Equation (a), than that in the case where the conventional application management section is used as is.

Here, since n>1 and m>1, it is understood that the addition of the new application management section can cause the number of processings of exclusive control to be reduced when multiple new applications are added.

This means that the total man-hours can be reduced by aggregating the processings. In particular, for the conventional application management section, no setting change of exclusive control occurs except that for an increase (for region 365) corresponding to one conventional application (367) whatever number of new applications is added. Accordingly, the following advantage is provided that the resource management concerning the new applications can be closed within the new application management section so that the influences on the conventional application management section and the conventional applications can be reduced (an inconsistency occurred at the new application may be prevented from being spread to the conventional applications).

### EFFECTS OF THE INVENTION

The present invention enables hardware control from an application in a newly created different process when the hardware control is being performed in a conventional application. As a result, decomposition into modules, such as a common application section including the hardware control, a new application section, a new application section in a different process, and a system section, becomes possible. Accordingly, in the hardware frequently modified in response to the advancement of technologies or a cost reduction request, the system section can be separated from the influences at the time of the changes, thereby improving the stability.

Hence, a common function which is essential to featuring a product can be separated from the influences at the time of addition of a new function which influences the added value of the product, thereby increasing the stability. As a result, the addition of the new function increasing the added value of the product can be facilitated.

### BRIEF DESCRIPTION OF THE DRAWINGS

FIG. 1 is a functional block diagram showing an example of a basic configuration of an electronic apparatus according to an embodiment of the present invention.

FIG. 2 is a view showing a configuration example of an ordinary electronic apparatus in which operation system (OS) and applications are integrated.

FIG. 3 is a view showing the functional blocks of FIG. 1 in detail.

FIG. 4 is a view showing an expansion example in a single process according to Embodiment 1.

FIG. 5 is a sequence diagram concerning application activation in a single process shown in FIG. 9 according to Embodiment 1.

FIG. 6 is a sequence diagram showing execution processing (in a single process) of a new application according to Embodiment 1.

FIG. 7 is a view showing termination (in a single process) of a new application according to Embodiment 1.

FIG. 8 is a sequence diagram showing a processing an abnormal system in which a new application spontaneously terminates, according to Embodiment 1.

FIG. 9 is a sequence diagram showing an example of switching processing (in a single process) of new applications according to Embodiment 1.

FIG. 10 is a sequence diagram of new application switching in a single process according to Embodiment 2.

FIG. 11 is a functional block diagram showing a configuration example of an electronic apparatus for showing an extended example in a different process according to Embodiment 3, and corresponds to FIG. 1. This is an example in which both a different Process B having a new application NEW-B and a different Process C having a new application NEW-C are added in addition to Process A in FIG. 1.

FIG. 12 is a sequence diagram in activating a new application in a different process according to Embodiment 3.

FIG. 13 is a sequence diagram in performing a new application in the different process according to Embodiment 3.

FIG. 14 is a sequence diagram in terminating a new application in the different process according to Embodiment 3.

FIG. 15 is a sequence diagram in spontaneously terminating (an abnormal system) a new application in the different process according to Embodiment 3.

FIG. 16 is a sequence diagram of a switching processing of new applications in the different process according to Embodiment 3.

FIG. 17 is a functional block diagram showing a configuration example of an electronic apparatus when a new application is in a different process from that of a common application and also when the resource management is further performed in the new application, according to Embodiment 4 of the present invention.

FIG. 18 is a sequence diagram of a processing in activating a new application according to Embodiment 4.

FIG. 19 is a sequence diagram of a processing in performing a new application according to Embodiment 4.

FIG. 20 is a sequence diagram of a processing in terminating a new application according to Embodiment 4.

FIG. 21 is a sequence diagram of a processing in spontaneously terminating (in a abnormal system) a new application according to Embodiment 4.

FIG. 22 is a sequence diagram of a switching processing of new applications according to Embodiment 4.

FIG. 23 shows examples of graphic-resource switching due to application switching.

FIG. 24 is a view showing a configuration example when the present embodiment is applied to a digital television receiver.

FIG. 25 is a view showing a configuration diagram when the techniques according to the present embodiments are applied to a recorder-reproducer, e.g., a HDD recorder, among the examples in which these techniques are applied to specific apparatuses.

FIG. 26 is a view showing a configuration diagram when the techniques according to the present embodiments are applied to a mobile terminal, e.g., a mobile phone with a one-segment view function, among the examples in which these techniques are applied to specific apparatuses.

FIG. 27 is a schematic view showing problems on the resource exclusive control in the electronic apparatus shown in FIG. 2.

FIG. 28 is a view showing a simple configuration example when conventional applications are managed by a conventional application management section.

FIG. 29 is a view showing a relationship of resource exclusive control between before transition and after transition in the configuration of FIG. 28.

FIG. 30 is a view showing a situation where a new application management section is newly added to the configuration of FIG. 28.

FIG. 31 is a view showing a relationship of resource exclusive control between before transition and after transition in the configuration of FIG. 30.

### DESCRIPTION OF SYMBOLS

1 system
3 main body section
11 conventional application (CURRENT-A)
15 conventional application (CURRENT-B)
17 conventional application management section
21 communication section
23 working memory region (RAM)
25 sound reproduction section
27 nonvolatile RAM section
31 graphic section (firmware)
33 new application NEW-A
35 new application management section
37 new application NEW-B
39 new application framework
41 library Z
43 communication section
51 display

### BEST MODES FOR CARRYING OUT THE INVENTION

In this specification, a first function refers to a function essential for the operation of an electronic apparatus. When the electronic apparatus is developed as series, the first function refers to a standard function common to models in the series, i.e., a function independent of the models, or the first function refers to a function common to all the models.

For example, the first function refers to a call phone function for the mobile phone, whereas the first function refers to a series of functions for receiving broadcast waves and displaying the same on a screen for TV.

A second function refers to a newly added function different from the first function, a function which is added to a standard function depending on a model, and a function other than a function common to all the models and inherent to the model. In short, the boundary for discrimination between the first function and the second function may be movable depending on the development strategy/product strategy and the like. The first function and the second function may be discriminated from each other depending on a difference in the resource management layer.

Hereinafter, an electronic apparatus according to an embodiment of the present invention will be described with reference to the accompanying drawings. As the electronic apparatus, a liquid crystal television receiver is basically taken as an example, and is described with a case in mind, in which a new function is added thereto. This embodiment can be applied to other electronic apparatuses, as a matter of course.

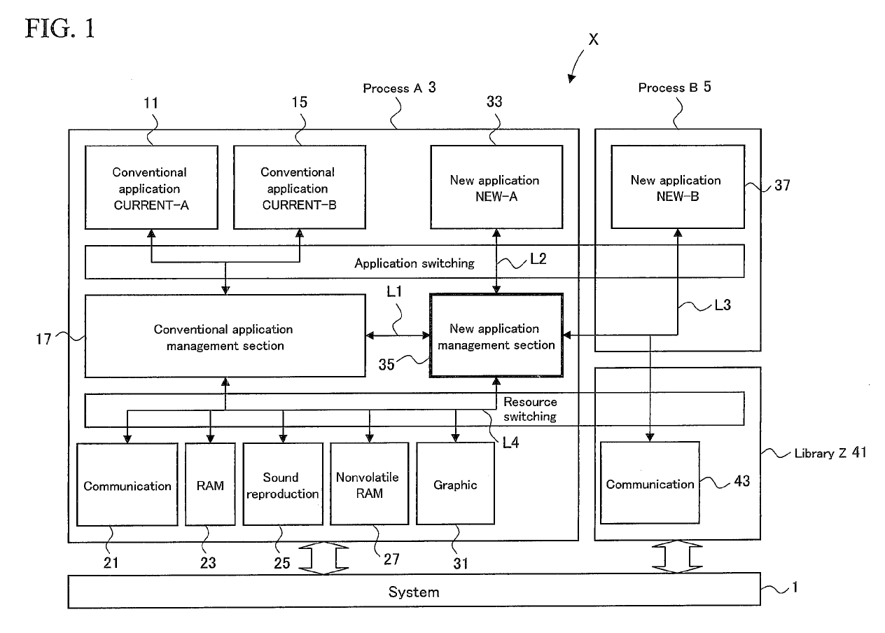

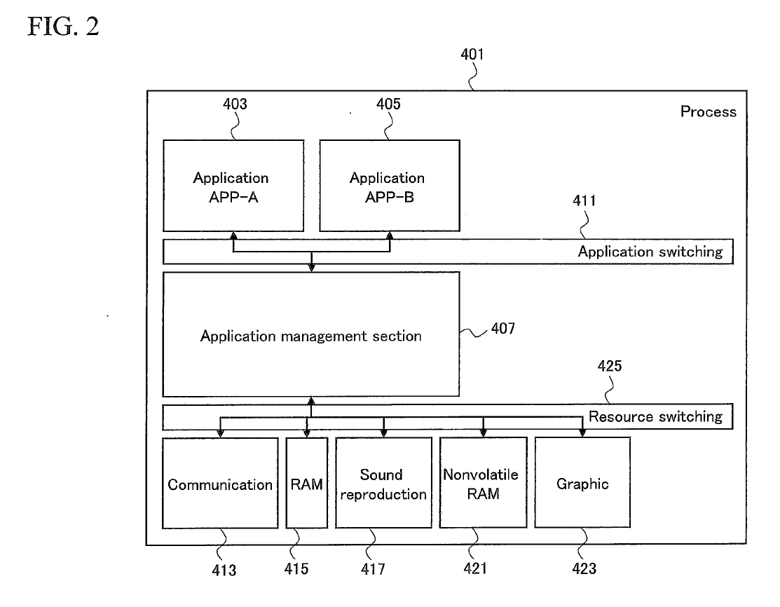

FIG. 1 is a functional block diagram showing an example of a basic configuration of the electronic apparatus according to this embodiment. As shown in FIG. 1, an electronic apparatus X according to this embodiment has the following configuration. First, a function provided as a common application includes the following modules. As the configuration similar to that of FIG. 2, the electronic apparatus X includes a system 1 and a main body section 3.

The main body section 3 is provided with a conventional application management section 17 and conventional applications (CURRENT-A) 11 and (CURRENT-B) 15. Furthermore, for illustrative purposes, the main body section is provided with resources of communication 21, working memory region (RAM) 23, sound reproduction 25, nonvolatile RAM 27, graphic 31, and the like, as hardware resources necessary for functioning in a hardware implementing certain functions.

In addition, the main body section 3 is provided with a new application management section 35 for managing a new application NEW-A 33, and the resources for the hardware are switched between the new application management section 35 and the application management section 17.

When Process B 5 having a new function is added to the main body section 3 having Process A, the new application management section 35 also manages a resource of this new application NEW-B 37.

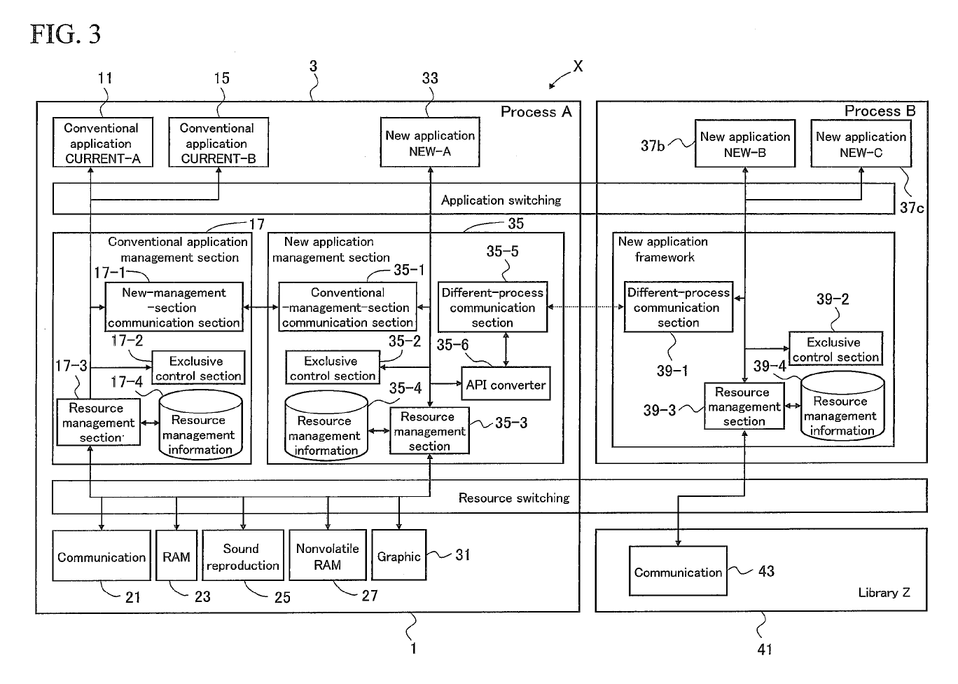

FIG. 3 is a view showing functional blocks of FIG. 1 in detail. The conventional application management section 17 is connected to the conventional applications 11, 15, and includes a new-management-section communication section 17-1 which communicates with the new application management section 35, an exclusive control section 17-2 for performing exclusive control, a resource management section 17-3 which is connected to hardware resources necessary for implementing functions and performs resource management, and a resource management information storing section 17-4 which is connected to the resource management section 17-3 and stores resource management information.

The new application management section 35 includes functional blocks each connected to the new application NEW-A 33, the functional blocks including: a conventional-management-section communication section 35-1 which communicates with the conventional application management section 17; an exclusive control section 35-2 for performing exclusive control; a resource management section 35-3 which is connected to the hardware resources necessary for implementing functions and performs resource management; a resource management information storing section 35-4 which is connected to the resource management section 35-4 and stores resource management information; a different-process communication section 35-5 which communicates with a different process; and an API conversion section 35-6 for performing API conversion.

Furthermore, Process B which is a process different from Process A and can activate new applications NEW-B (37b) and NEW-C (37c) includes a different-process communication section 39-1 capable of communicating with the new application management section 35, an exclusive control section 39-2, a resource management section 39-3, and a storing section 39-4 which is connected to the resource management section 39-3, and stores resource management information. The resource management section 39-3 performs resource control on the communication section contained in a library Z 41.

Here, FIG. 3 shows a “new application framework”. A “second new application management section” described in claims is referred to as the new application framework for convenience of description.

In the above-described configuration, such control is made to cause the resources to be switched if a new application is added and this added new application is activated.

Note that, in respect to the exclusive control on the resource, this embodiment sets the number of modules allowed to use the resource simultaneously to one, however, similar exclusive control can be performed also in the case where two or more modules are allowed to use.

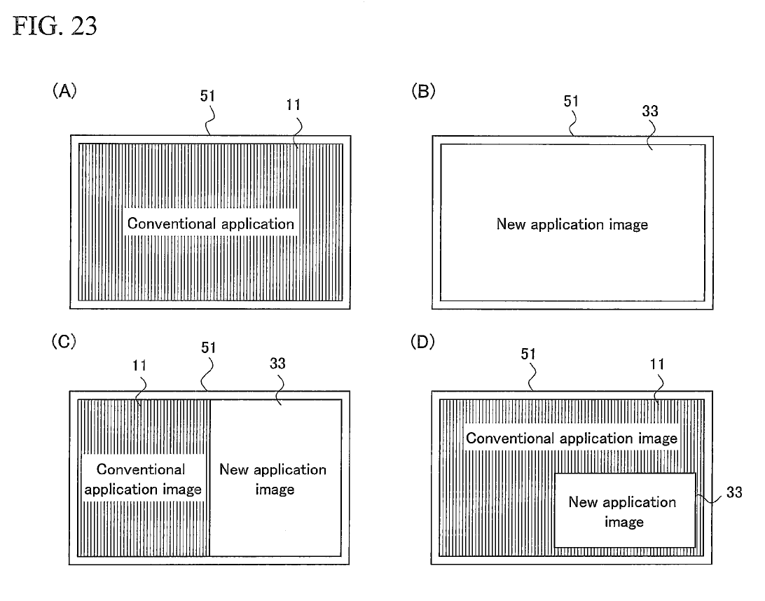

For example, the exclusive control on the graphic resource is described as an example with reference to FIG. 23. FIG. 23 shows examples of graphic-resource switching due to application switching. In a display 51 of the television receiver, when the number of modules allowed to use it simultaneously is one, the conventional application 11 is displayed while the conventional application 11 is using the resource (FIG. 23 (A)). If the new application 33 is using the resource, the screen is switched to a display screen of the new application 33 (FIG. 23 (B)). In each of these cases, the conventional application 11 and the new application 33 are completely exclusive of each other.

However, if the number of modules allowed to use it simultaneously is two or more, there are cases where a split and exclusive operation (11 and 33) is possible in a region 51 to be updated as shown in FIG. 23(C), and where an exclusive operation is possible as an superposing layer (11, 33) as shown in FIG. 23(D). In the above cases, a similar management method as that used for the cases shown in FIGS. 23(A), (B) can be employed for controlling the respective regions.

A description is given below of a processing example in the case where the new application management section is added to the common application and the new applications (NEW-A, NEW-B, and NEW-C) are further added.

Considering the states of the new application and the common application, there are three cases as follows.

a) a case where the new application and the common application are within a single process,

b) a case where the new application is in a different process from that of the common application, and

c) a case where the new application is in a different process from that of the common application, and the resource management is further performed within the new application.

The following processings for each of the above-described cases will be described.

1) activation of a new application,

2) termination of a new application,

3) behavior during execution of a new application, and

4) switching between new applications.

Note that, as a combination thereof, switching processings may be required from/to
a new application on a common application,
a new application on a different process, and
a new application on a new framework,
   however, the description thereof is omitted because the switching processings respectively comply with the processing in a single application.

Hereinafter, more specific configurations and processings will be described using examples.

### EMBODIMENTS

### Embodiment 1

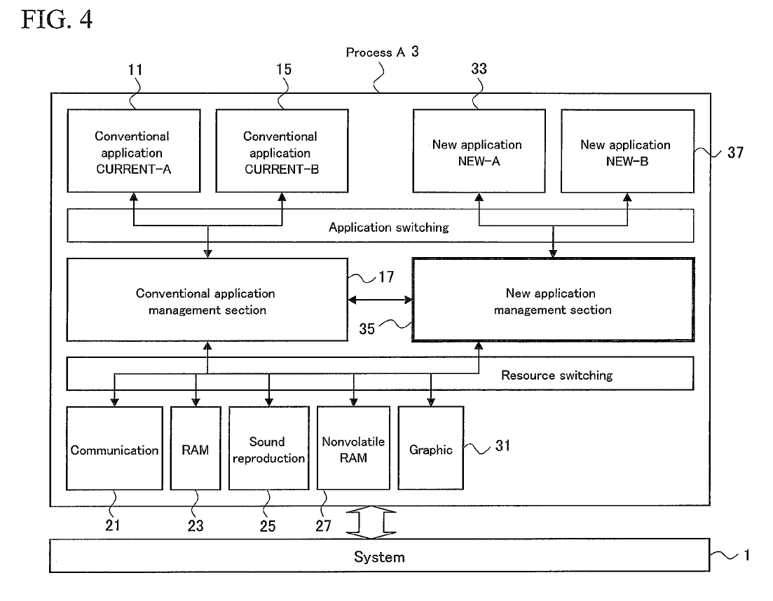

Embodiment 1 shows a first case among the cases where a new application is included in a single process together with a common application. FIG. 4 is a module configuration diagram according to Embodiment 1, and is a view showing an extended example in a single process. A difference from FIG. 1 lies in that the new application NEW-B 37 is provided in the same Process A3 where the conventional applications 11, are provided. The new application management section 35 manages the new applications NEW-A 33 and NEW-B 37.

In response to the switching between the conventional applications and the new applications, the manager for managing resources is switched from one to the other of the conventional application management section 17 and the new application management section 35.

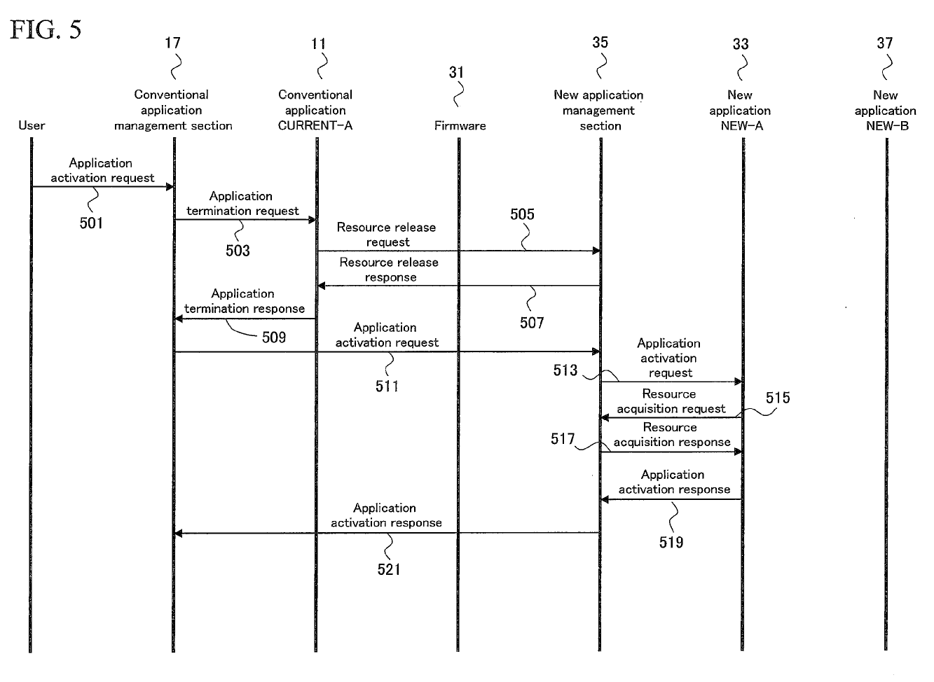

A sequence diagram with regard to the application activation in a single process shown in FIG. 4 is shown in FIG. 5. Upon receipt of an activation request (501) of a new application NEW-A from a user, the conventional application management section 17 notifies the conventional application CURRENT-A 11 of a termination request (503). The conventional application CURRENT-A 11 stops using resources currently in use, by performing termination of drawing, release of the working memory, and the like, and then deletes information of the conventional application CURRENT-A 11 from the resources that the new application management section 11 manages, and updates the resources into the unused state (505, 507). Thereafter, the resources of graphic, the working memory, and the like can be used in the new application.

After the conventional application CURRENT-A 11 terminates the processing and releases the resources, the conventional application CURRENT-A 11 notifies the conventional application management section of an application termination response (509).

The conventional application management section 17 makes an activation request of the new application NEW-A 33 to the new application management section 35 (511). Upon receipt of the new application activation request (511) from the conventional application management section 17, the new application management section 35 makes an activation request to the new application NEW-A 33 (513).

The new application NEW-A 33 registers the information of the new application NEW-A 33, on the resources that the new application management section 35 manages, and updates the resources into the busy state (515, 517).

Hereinafter, the new application NEW-A 33 can perform processings of communication, computation, and the like using the working memory and start drawing on a graphic plane.

When the activation of the new application NEW-A 33 is completed, the new application NEW-A 33 sends an activation response of the new application NEW-A to the new application management section 35 (519). The new application management section 35 sends a new application activation response to the conventional application management section 17 (521).

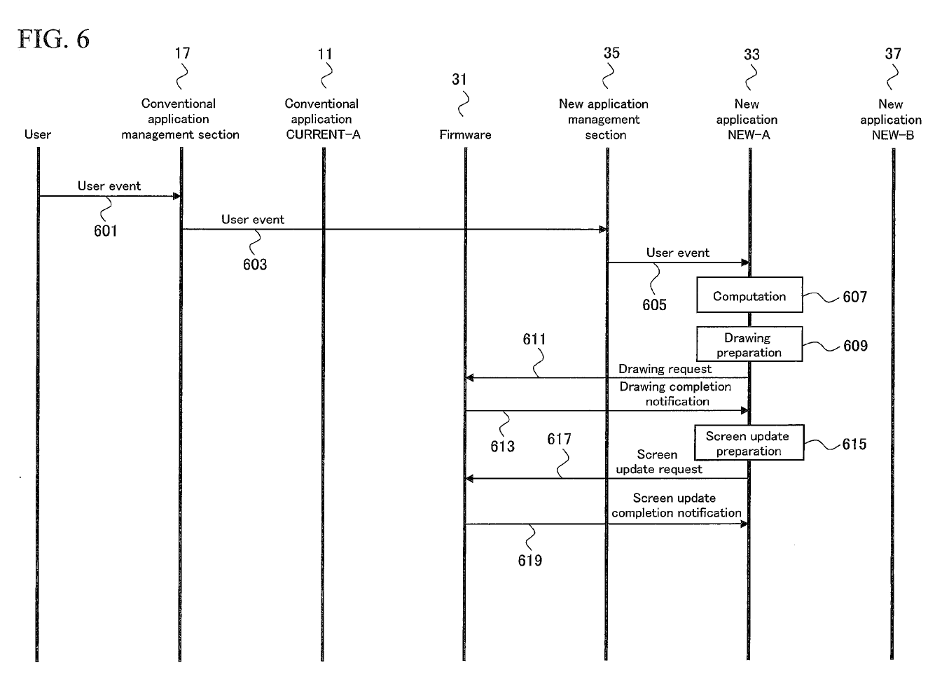

Next, the execution processing (in a single process) of a new application is described with reference to FIG. 6. In the processing shown in FIG. 6, focusing on the working memory region (RAM) and graphic as the resources, a description is given of a processing flow from the execution of processing and computation by the new application upon execution of a certain operation by a user, until some information is displayed on the display device.

As shown in FIG. 6, a user event 601 generated by the operation of a user is notified, via the conventional application management section 17 and new application management section 35 (603), to the new application NEW-A 33 (605). The new application NEW-A performs computation 607 and drawing preparation 609, and makes a drawing request to the firmware (graphic) 31 (611). The firmware 31 issues a drawing completion notification upon termination of the processing.

When the firmware 31 performs the drawing processing for all the required processings and notifies an all-the-drawing completion notification to the new application NEW-A 33 (613), the new application NEW-A 33 performs screen update preparation (615) and then makes a screen update request to the firmware 31 (617). The firmware 31 issues a screen update completion notification upon termination of the processing (619). Through the above-described processings, a screen (on which certain update is performed, if required) is displayed in response to the operation of the user.

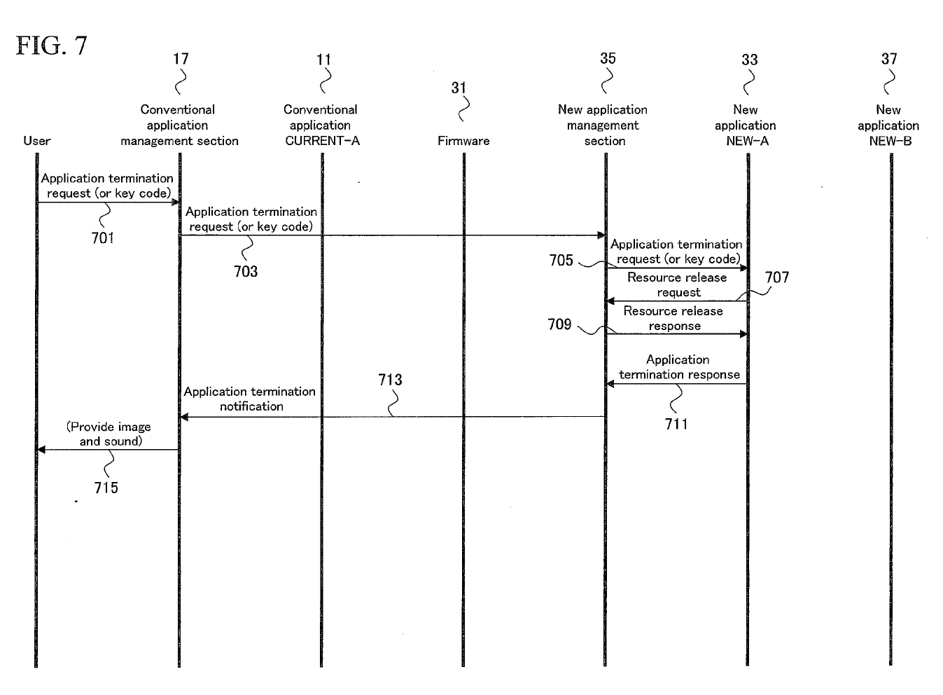

Next, termination of a new application (in a single process) is described with reference to FIG. 7. As shown in FIG. 7, upon receipt of a termination request (701) of the new application NEW-A 33 from a user, the conventional application management section 17 makes an application termination request (703) to the new application management section 35.

Here, the following forms are included in the application termination requests (701, 703, and 705).

a) a form that can be recognized as the “termination request” in the conventional application management section 17,

b) a form that can not be recognized as the “termination request” until being received by the new application management section 35, and

c) a form that can not be recognized as the “termination request” until being received by the new application 33.

For example, a power key or the like commonly serves as a termination request throughout the apparatus as in (a), but the case where there is an application terminating key or the like falls under (b). Moreover, a termination command which is set in a menu on an application falls under (c). In the case of (c), for the conventional application management section 17 and the new application management section 35, the application termination requests 701, 703 serve as simply events (key codes) but either of them is processed in a similar manner.

That is, the new application 33 in a state of receiving the application termination request from the conventional application 11 performs application termination processings from 707 onward. When starting the application termination processing in response to receipt of the notification of the application termination request 705 from the new application management section 35 to the new application NEW-A 33, the new application NEW-A 33 stops the use of currently using resources, by performing termination of drawing, release of the working memory, and the like, and then deletes the information of the new application NEW-A 33 from the resources that the new application management section 35 manages, and updates the resources into the unused state (707, 709).

Hereinafter, the resources of graphic, working memory, and the like can be used in the conventional application 11. When the new application NEW-A 33 terminates the processing and releases the resources, the new application NEW-A 33 notifies the new application management section 35 of an application termination response (711). The new application management section 35 issues an application termination notification to the conventional application management section 11 (713).

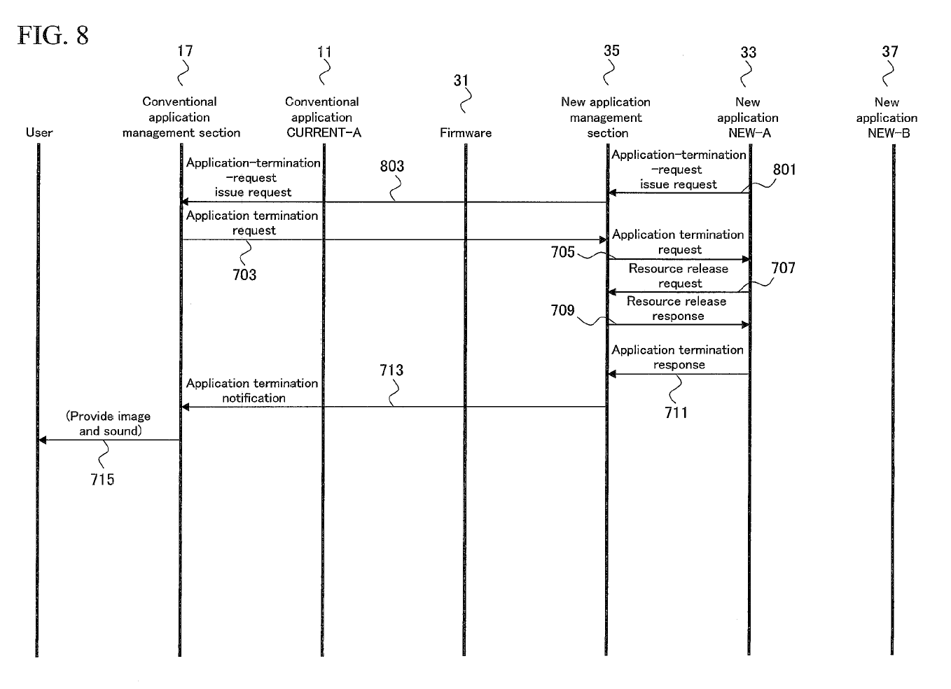

Next, a description is given of the processing an abnormal system in which a new application spontaneously terminates with reference to FIG. 8. A new application may be terminated irrespective of the intention of a user when an abnormality occurs in the new application 33, for example.

When such a spontaneous termination occurrence event arises, the new application NEW-A 33 makes an application-termination-request issue request to the new application management section 35 (801), and the new application management section 35 makes an application-termination-request issue request 803 to the conventional application management section 17. Hereinafter, the termination processings are performed in a similar manner as an ordinary new application termination processing (703-715).

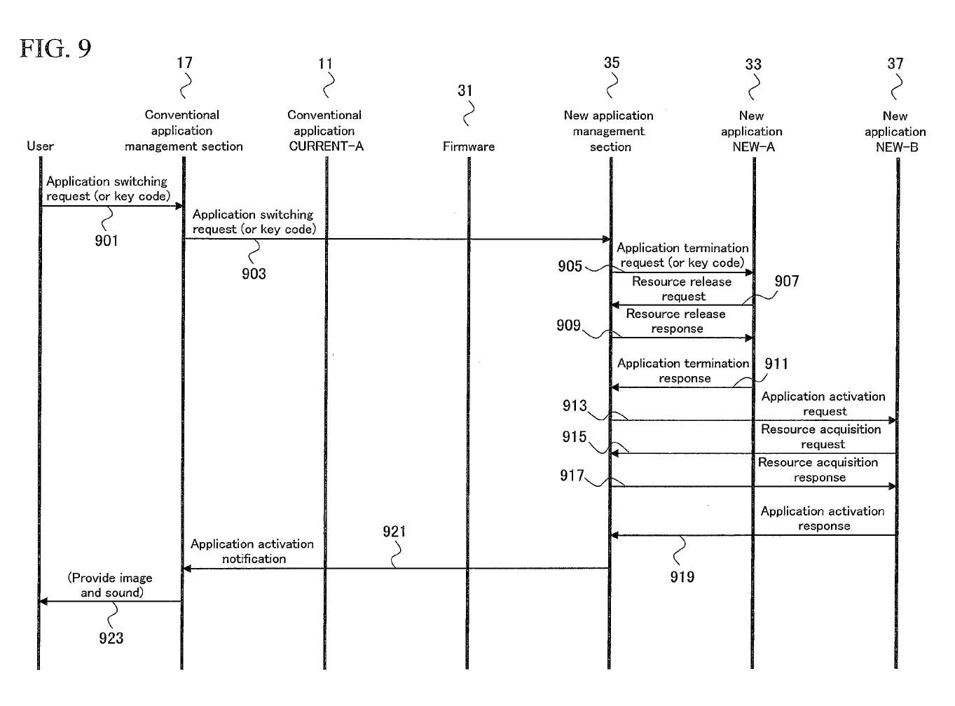

Next, a switching processing of new applications (in a single process) is described with reference to FIG. 9. First, upon receipt of an application switching request 901 from the user, the conventional application management section 17 makes an application switching request 903 to the new application management section 35. Here, the following forms are included in the application switching requests (901, 903, and 905).

a) a form that can be recognized as the “switching request” in the conventional application management section,

b) a form that can not be recognized as the “switching request” until being received by the new application management section, and

c) a form that can not be recognized as the “switching request” until being received by the new application.

For example, an EPG activation (display) key or the like commonly serves as a switching request throughout the apparatus as in (a), and the case where there is an application switching key or the like falls under (b). Moreover, a switching command set in a menu on the application falls under (c). In the case of (c), for the conventional application management section 17 and the new application management section 35, the application switching requests 901, 903 serve as simply events (key codes) but either of them is processed in a similar manner. That is, the new application 33 in a state of receiving the application switching request from the conventional application 11 performs the application termination processings from 905 onward.

The new application management section 35 makes an application termination request 905 to the new application NEW-A 33. The new application NEW-A 33 stops the use of currently using resources, by performing termination of drawing, release of the working memory, and the like, and then deletes the information of the new application NEW-A 33 from the resources that the new application management section 35 manages, and updates the resources into the unused state (907, 909).

When the new application NEW-A 33 terminates the processing and releases the resources, the new application NEW-A 33 notifies the new application management section 35 of an application termination response (911).

The new application management section 35 makes an activation request to the new application NEW-B 37 (913). The new application NEW-B 37 registers the information of the new application NEW-B 37, on the resources that the new application management section 35 manages, and updates the resources into the busy state (915, 917).

When the activation of the new application NEW-A 37 is completed, the new application NEW-B 37 sends an activation response of the new application NEW-B 37 to the new application management section 35 (919). The new application management section 35 sends a new application activation notification to the conventional application management section 17 (921). The conventional application management section 17 provides an image or sound to the user (923).

### Embodiment 2

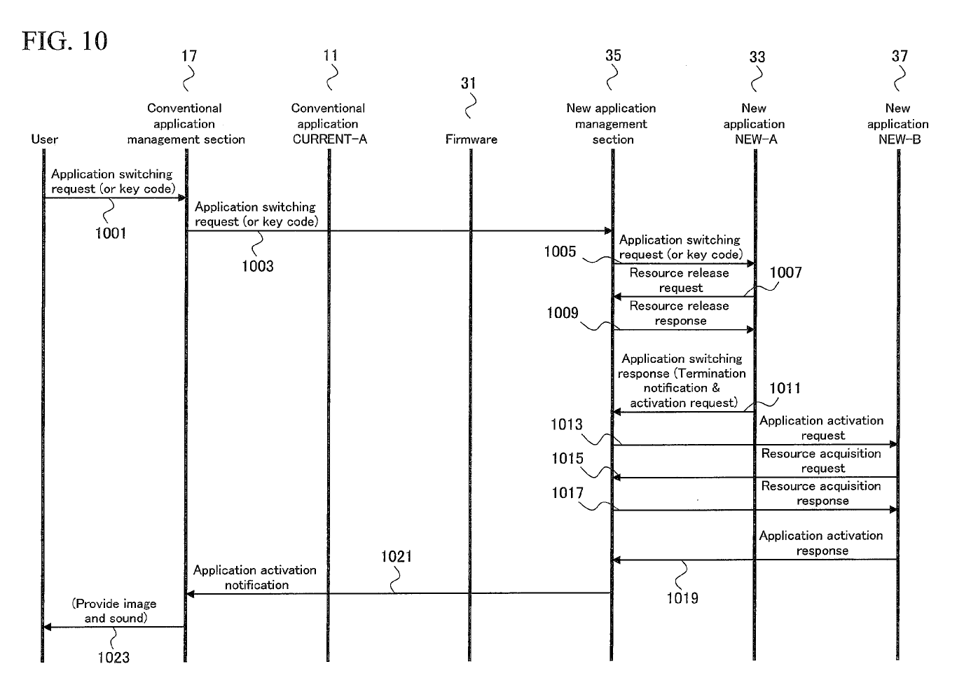

Embodiment 2 shows a case where a new application before the switching to the other and the other application after switching from the new application perform a cooperative operation in a single process. A description is given of this case based on a sequence diagram. FIG. 10 is a sequence diagram of new application switching in a single process. As shown in FIG. 10, upon receipt of an application switching request from the user (1001), the conventional application management section 17 makes an application switching request 1003 to the new application management section 35.

Note that, as described in the switching of new applications (in a single process), application switching requests (1001, 1003, and 1005) may be simply events (key codes). The new application management section 35 makes the application switching request 1005 to the new application NEW-A 33.

The new application NEW-A 33 stops the use of currently using resources, by performing termination of drawing, release of the working memory, and the like, and then deletes the information of the new application NEW-A 33 from the resources that the new application management section 35 manages, and updates the resources into the unused state (1007, 1009).

When the new application NEW-A terminates the processing and releases the resources, the new application NEW-A 33 sends an application switching response 1011 to the new application management section 35. The new application management section 35 makes an activation request 1013 to the new application NEW-B 37.

The new application NEW-B 37 registers the information of the new application NEW-B 37, on the resources that the new application management section 35 manages, and updates the resources into the busy state (1015, 1017).

When the activation of the new application NEW-A 37 is completed, the new application NEW-B 37 sends an activation response 1019 of the new application NEW-B 1019 to the new application management section 35, and upon receipt of this response, the new application management section 35 sends a new application activation notification 1021 to the conventional application management section 17.

Upon receipt of the new application activation notification 1021 from the new application management section 35, the conventional application management section 17 provides an image and sound to the user (1023).

### Embodiment 3

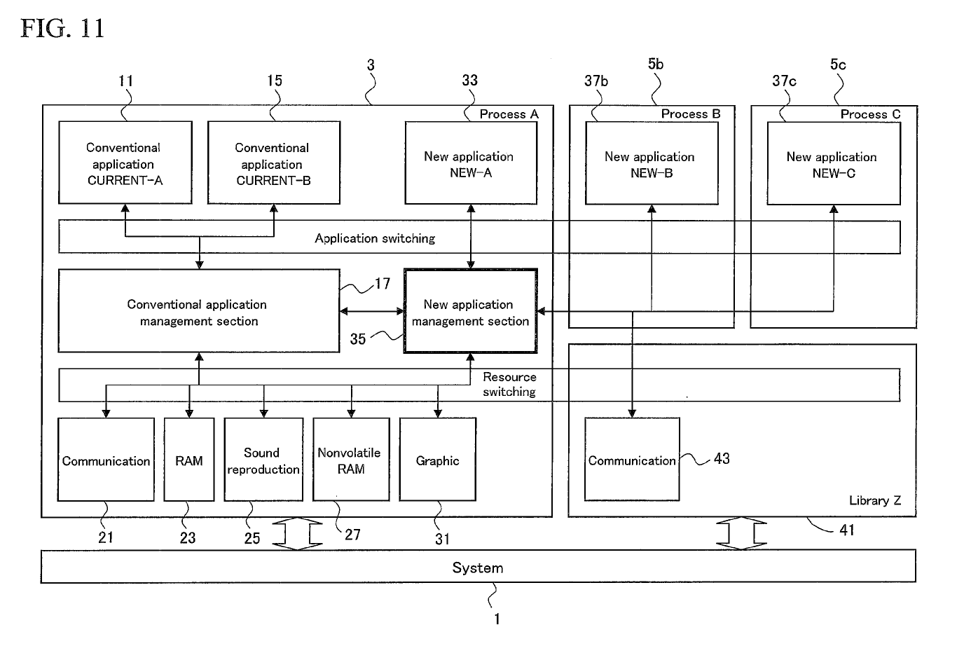

Embodiment 3 shows a case where a new application is in a different process from that of the common application. FIG. 11 is a functional block diagram showing a configuration example of an electronic apparatus, showing an extended example in a different process, and corresponds to FIG. 1. This is an example in which both a different Process B (5b) having a new application NEW-B (37b) and a different Process C (5c) having a new application NEW-C (37c) are added in addition to Process A in FIG. 1.

In this case, the communication section 43 can be commonly used in both of the different Process B (5b) and the different Process C (5c).

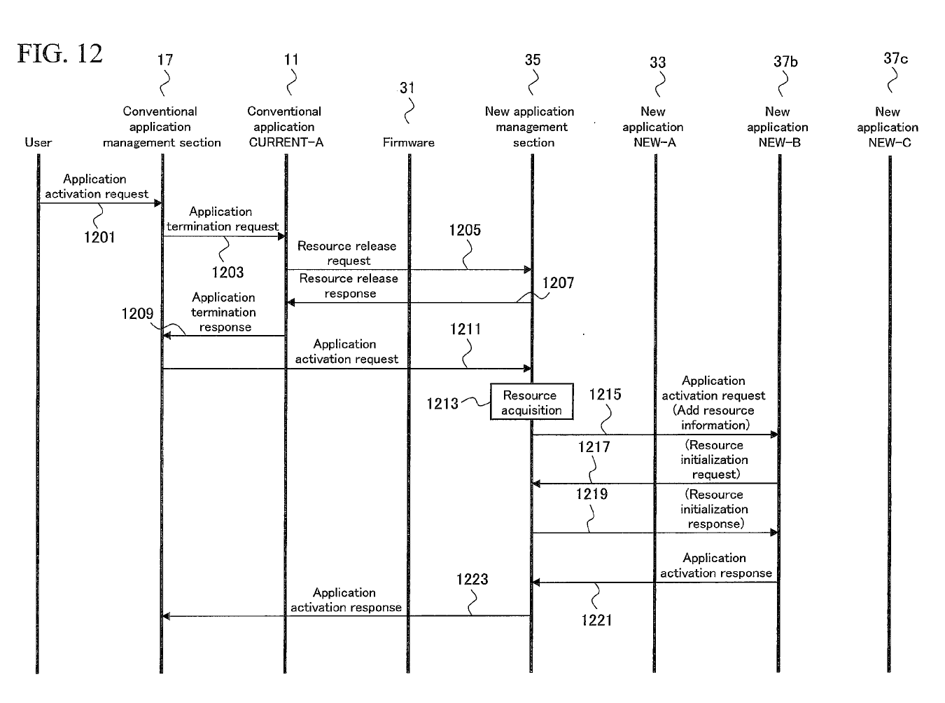

New application activation in a different process is described with reference to FIG. 12. Upon receipt of an activation request 1201 of the new application NEW-B from the user, the conventional application management section 17 notifies the conventional application CURRENT-A 11 of a termination request 1203.

The conventional application CURRENT-A 11 stops the use of currently using resources, by performing termination of drawing, release of the working memory, and the like, and then deletes the information of the conventional application CURRENT-A 11 from the resources that the new application management section 35 manages, and updates the resources into the unused state (a resource release request 1205 and a resource release response 1207). Thereafter, the resources of graphic, the work memory, and the like can be used in the new application.

When the conventional application CURRENT-A 11 terminates the processing and releases the resources, the conventional application CURRENT-A 11 notifies the conventional application management section 17 of an application termination response 1209. The conventional application management section 17 makes an activation request 1211 of the new application NEW-B to the new application management section 35.

Upon receipt of the new application activation request 1211 from the conventional application management section 17, the new application management section 35 acquires a resource (1213), and makes an activation request to the new application NEW-B (37b) with resource information appended (1215). The new application NEW-B (37b) performs initialization of the resource, if required (1217, 1219).

Thereafter, the new application NEW-B (37b) can perform processings of communication, computation, and the like using the work memory and start drawing on the graphic plane.

When the activation of the new application NEW-B (37b) is completed, the new application NEW-B (37b) sends an activation response 1221 of the new application NEW-B to the new application management section 35. Upon receipt of this activation response, the new application management section 35 sends a new application activation response 1223 to the conventional application management section 17.

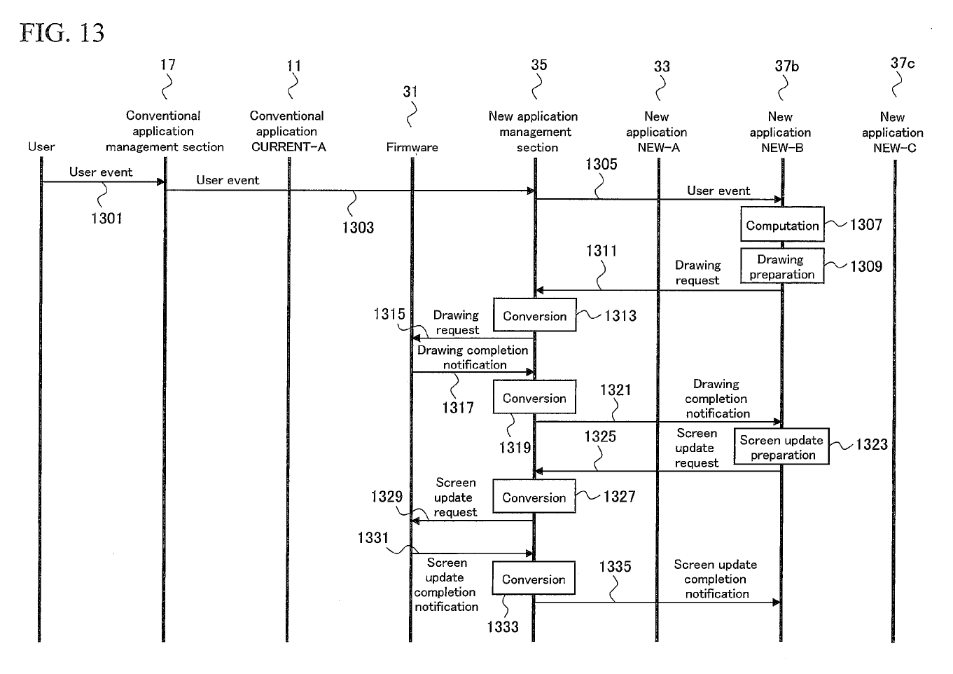

Next, execution of the processing of a new application in a different process is described with reference to FIG. 13. Here, focusing on the working memory region (RAM) and graphic as the resource, a description is given of the processing from the execution of processing and computation by the new application upon execution of a certain operation by a user, until some information is displayed on the display device.

A user event 1301 generated by the operation of the user is notified to the new application NEW-B (37b) via both the conventional application management section and the new application management section 35 (1303, 1305). The new application NEW-B (37b) performs computation 1307 and drawing preparation 1309, and makes a drawing request 1311 to the new application management section 35. The new application management section 35 converts the drawing request to the API of the firmware 31 which is under exclusive control (1313), thereby notifying the firmware of the request (1315).

The firmware 31 issues a drawing completion notification 1317 upon termination of the processing, and the drawing completion notification is converted in the new application management section 35 (1319), and is then notified to the new application NEW-B (37b) (1321).

Here, when the drawing processing for all the required processings is performed and all the drawing completion notification are notified from the firmware 31 (1321), the new application NEW-B (37b) performs screen update preparation 1323, and makes a screen update request 1325 to the new application management section 35. The new application management section 35 converts the screen update request to the API of the firmware 31 which is under exclusive control (1327), thereby notifying the firmware (1329).

The firmware 31 issues a screen update completion notification 1331 upon termination of the processing, and the screen update completion notification is notified, via the new application management section 35 (conversion 1333), to the new application NEW-B (37b) (1335). In this manner, a screen (on which certain update is performed, if required) is displayed in response to the operation of the user.

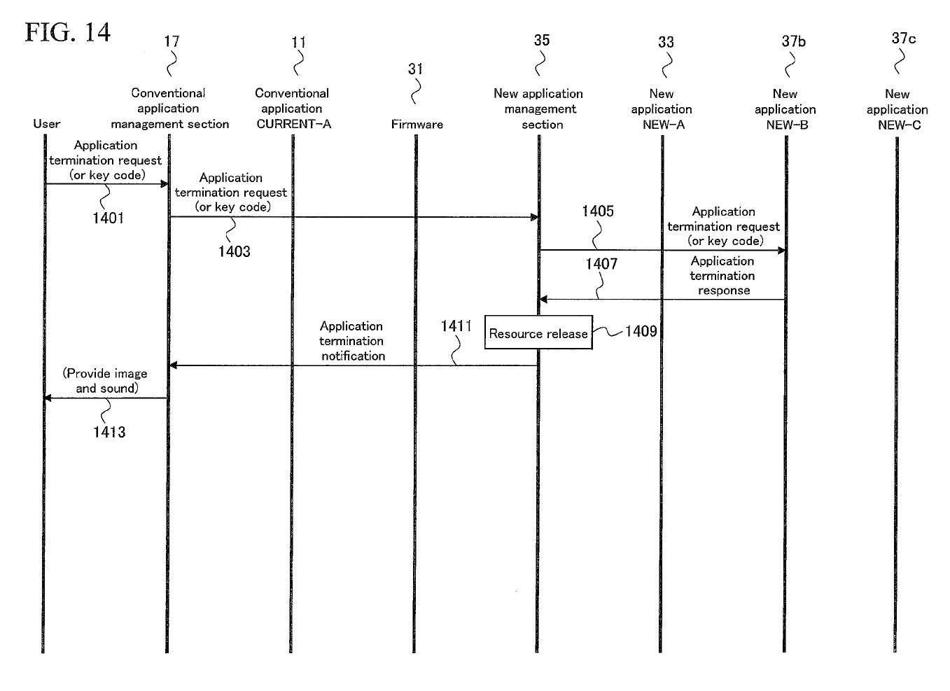

FIG. 14 is a sequence diagram showing a case where a new application in a different process terminates. Upon receipt of a termination request 1401 of the new application NEW-B (37b) from the user, the conventional application management section 17 makes an application termination request 1403 to the new application management section 35.

Here, as described in the new application termination in a single process, application termination requests 1401, 1403, and 1405 may be simply events (key codes).

Upon receipt of the application termination request from the conventional application, the new application management section 35 makes the application termination request 1405 to the new application NEW-B (37b).

The new application NEW-B (37b) stops the use of currently using resources, by performing termination of drawing, release of the working memory, and the like, and then notifies the new application management section 35 of an application termination response 1407. The new application management section 35 deletes the information of the new application NEW-B (37b) from the resources that the new application management section 35 manages, and updates the resources into the unused state (release of resources 1409). Thereafter, the resources of graphic, working memory, and the like can be used in the conventional application.

When the new application management section 35 performs the release of resources 1409, the new application management section 35 issues an application termination notification 1411 to the conventional application management section 17, and the conventional application management section 17 provides an image and sound to the user (1413).

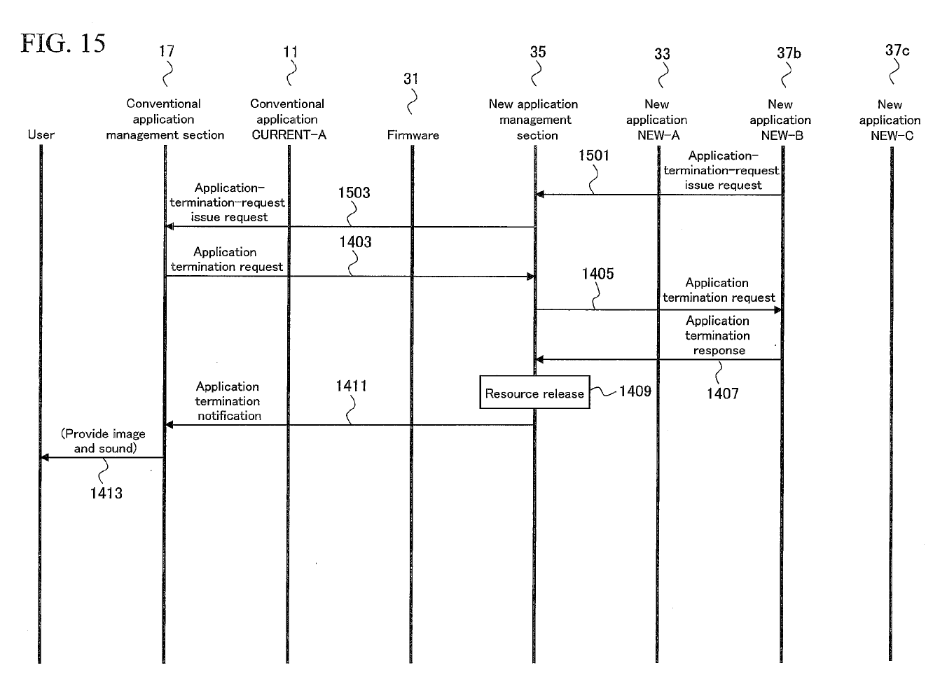

Next, spontaneous termination of a new application in a different process (an abnormal system) is described with reference to FIG. 15. A new application may be terminated irrespective of the intention of the user when an abnormality occurs in the new application, for example.

When a spontaneous termination occurrence event arises, for example, the new application NEW-B (37b) makes an application-termination-request issue request to the new application management section 35, and the new application management section 35 makes an application-termination-request issue request 1503 to the conventional application management section 17. Thereafter, the termination processings are performed in a similar manner as an ordinary new application termination processing (1403-1413).

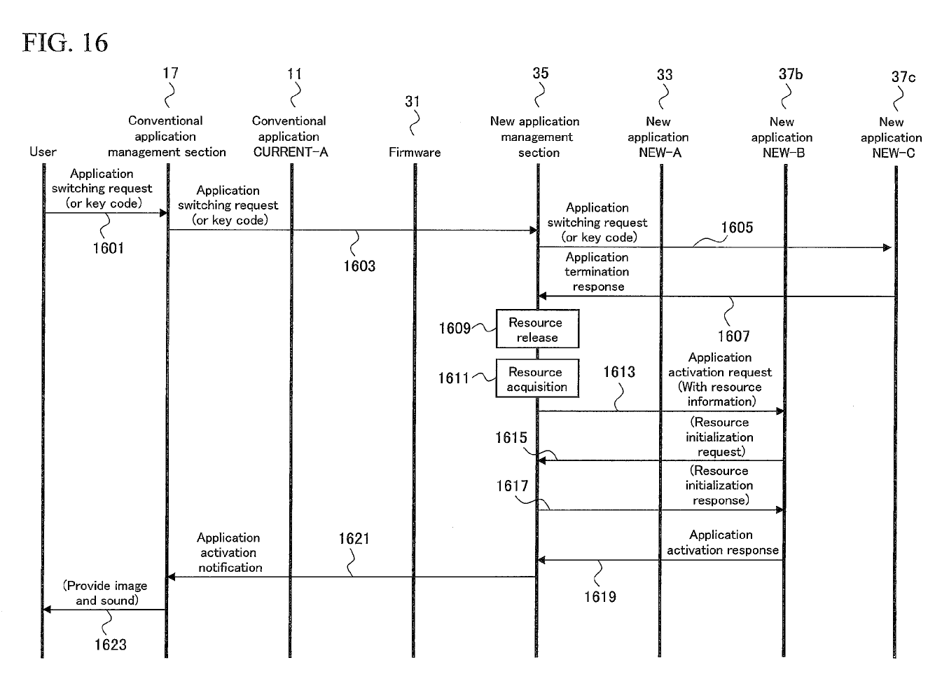

Next, new application switching in different processes is described with reference to FIG. 16. First, upon receipt of an application switching request 1601 from the user, the conventional application management section 17 makes an application switching request 1603 to the new application management section 35. Here, as described in the new application switching in a single process, application switching requests (1601, 1603, and 1605) may be simply events (key codes).

The new application management section 35 makes an application termination request 1605 to the new application NEW-C (37c). The new application NEW-C (37c) stops the use of currently using resources, by performing termination of drawing, release of the working memory, and the like, and then notifies the new application management section 35 of an application termination response 1607. Upon receipt of the application termination response from the new application NEW-C (37c), the new application management section 35 deletes the information of the new application NEW-C (37c) from the resources that the new application management section 35 manages, and updates the resources into the unused state (release of resources 1609).

Thereafter, the new application management section 35 registers information of the new application NEW-B (37b), updates this resource into the busy state (registration of resource 1611), and makes an activation request 1613 to the new application NEW-B (37b). When the activation of the new application NEW-B (37b) is completed (1615, 1617), the new application NEW-B (37b) sends an activation response 1619 of the new application NEW-B (37b) to the new application management section 35. The new application management section 35 sends a new application activation notification 1621 to the conventional application management section 17. The conventional application management section 17 provides an image and sound to the user (1623).

### Embodiment 4

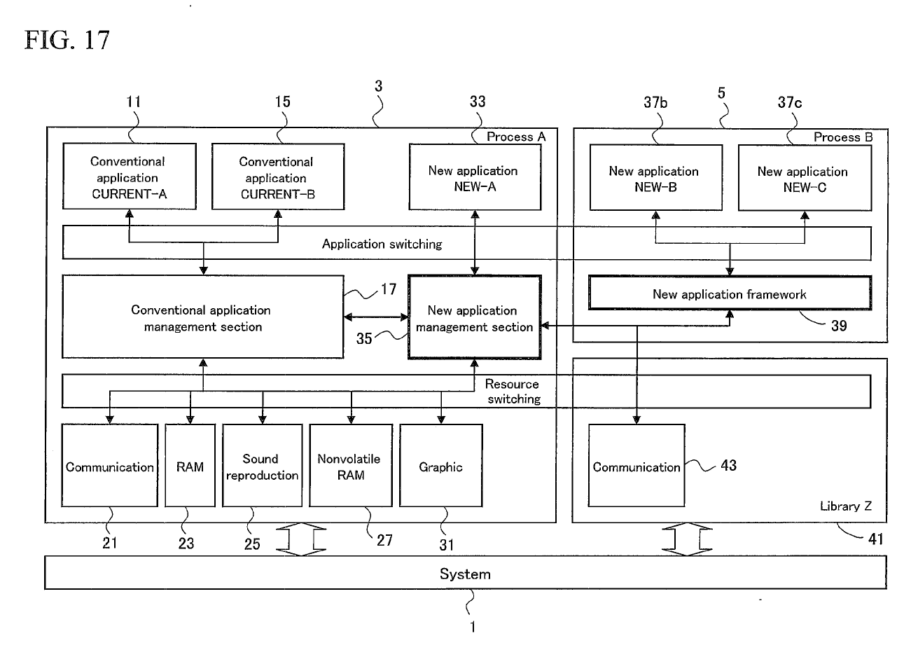

Next, a description is given of a case where a new application is in a different process from that of the common application and where the resource management is further performed within the new application. FIG. 17 is a functional block diagram showing a configuration example of an electronic apparatus according to this embodiment. As shown in FIG. 17, a new application framework 39 is provided in Process B5 which is different from Process A3, and this new application framework 39 is connected to the new application management section 35 as well as to the new application NEW-B (37b) and the new application NEW-C (37c).

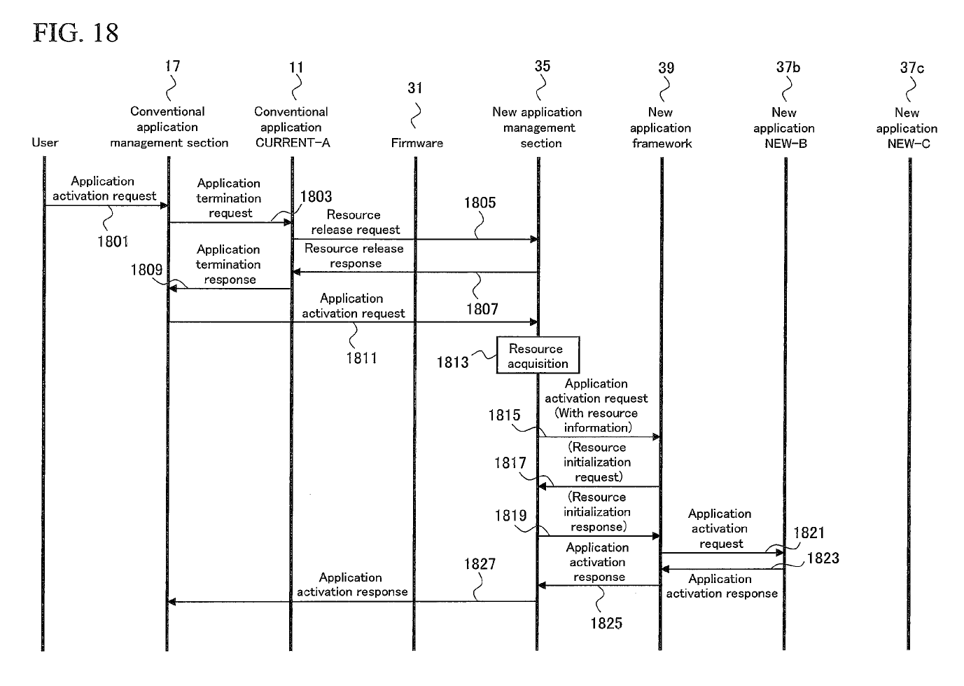

In the above-described configuration, the operation is performed as follows. With reference to FIG. 18, the activation of a new application in the new application framework is described.

Upon receipt of an activation request 1801 of the new application NEW-B (37b) from the user, the conventional application management section 17 notifies the conventional application CURRENT-A 11 of a termination request 1803.

The conventional application CURRENT-A 11 stops the use of currently using resources, by performing termination of drawing, release of the working memory, and the like, and then deletes the information of the conventional application CURRENT-A 11 from the resources that the new application management section 35 manages, and updates the resources into the unused state (1805, 1807). Thereafter, the resources of graphic, work memory, and the like can be used in the new application.

When the conventional application CURRENT-A 11 performs the termination of processings and the release of resources, the conventional application CURRENT-A 11 notifies the conventional application management section 17 of an application termination response 1809. The conventional application management section 17 makes an activation request 1811 of the new application NEW-B (37b) to the new application management section 35.

Upon receipt of the new application activation request 1811 from the conventional application management section 17, the new application management section 35 acquires a resource (1813), and makes an activation request 1815 to the new application framework 39 with resource information appended.

The new application framework 39 performs the initialization of the resource (1817, 1819), if required, and makes an activation request 1821 to the new application NEW-B (37b).

Thereafter, the new application NEW-B (37b) can perform processings of communication, computation, and the like using the work memory and start drawing on the graphic plane.

When the activation of the new application NEW-B (37b) is completed, the new application NEW-B (37b) sends an activation response 1823 of the new application NEW-B (37b) to the new application framework 39. The new application framework sends a new application activation response 1825 to the new application management section 35. The new application management section 35 sends a new application activation response 1827 to the conventional application management section 17.

In this way, the new application can be activated.

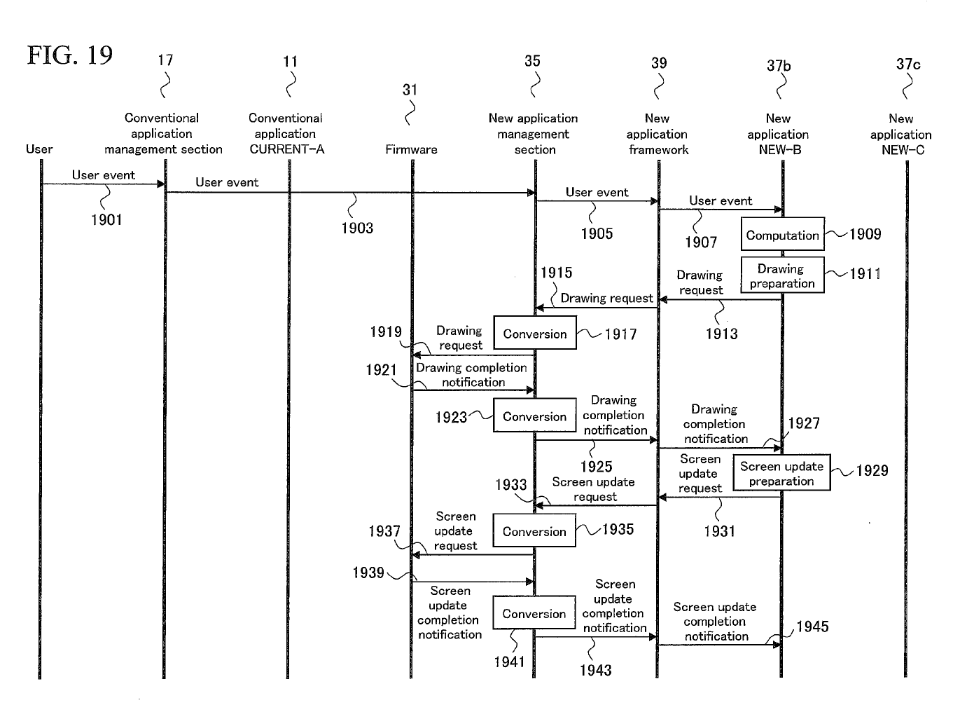

Next, execution of the processing of a new application in the new application framework is described with reference to FIG. 19. Here, focusing on the working memory region (RAM) and graphic as the resources, a description is given of the processing from the execution of processing and computation by the new application upon execution of a certain operation by a user, until some information is displayed on the display device.

A user event 1901 generated by the operation of the user is notified, via the conventional application management section 17, the new application management section 35, and the new application framework 39 (1903, 1905), to the new application NEW-B (37b) (1907). The new application NEW-B (37b) performs computation 1909 and drawing preparation 1911, and makes a drawing request to the new application management section 35 via the new application framework 39 (1913, 1915).

The new application management section 35 converts the drawing request 1915 to the API of the firmware which is under exclusive control (1917), thereby notifying the firmware 31 (1919).

The firmware 31 issues a drawing completion notification 1921 upon termination of the processing, and the drawing completion notification 1921 is notified, via both the new application management section 35 (conversion 1923 is performed here) and the new application framework 39 (1925), to the new application NEW-B 37b (1927). When the drawing processing for all the required processings is performed and all the drawing completion notification are notified from the firmware 31, the new application NEW-B (37b) performs screen update preparation 1929 and makes a screen update request to the new application management section 35 via the new application framework 39 (1931, 1933).

The new application management section 35 converts the screen update request 1933 to the API of the firmware which is under exclusive control (1935), thereby notifying the firmware (1937).

The firmware 31 issues a screen update completion notification 1939 upon termination of the processing, and the screen update completion notification is notified, via both the new application management section 35 (conversion 1941 is performed here) and the new application framework 39 (1943), to the new application NEW-B (37b) (1945). Through the above-described processings, a screen (on which certain update is performed, if required) is displayed in response to the operation of the user.

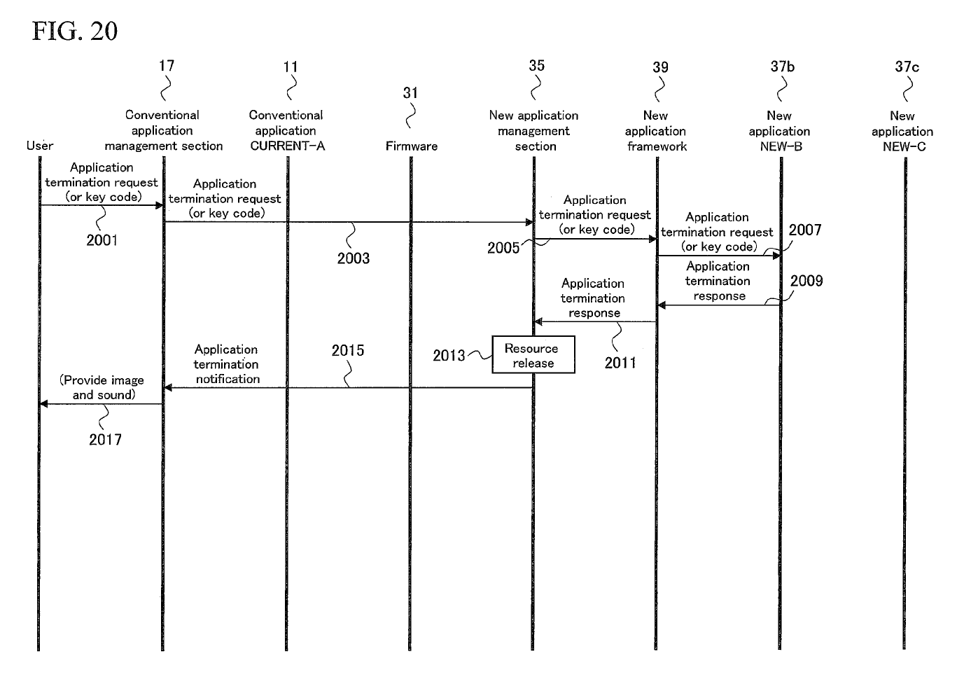

Next, the termination of a new application in the new application framework is described with reference to FIG. 20. First, upon receipt of a termination request 2001 of the new application NEW-B (37b) from the user, the conventional application management section 17 makes an application termination request 2003 to the new application management section 35.

Note that, as described in the new application termination in a single process, application termination requests (2001, 2003, and 2005) may be simply events (key codes).

Upon receipt of the application termination request 2003 from the conventional application management section 17, the new application management section 35 makes the application termination request 2005 to the new application framework 39. The new application framework 39 makes the application termination request 2007 to the new application NEW-B (37b).

The new application NEW-B (37b) stops the use of currently using resources, by performing termination of drawing, release of the working memory, and the like, and then notifies the new application framework 39 of an application termination response (2009). The new application framework 39 notifies the new application management section 35 of an application termination response 2011.

From the resources that the new application management section 35 manages, the new application management section 35 deletes the information of the new application framework 39 and updates the resources into the unused state (2013). Thereafter, the resources of graphic, working memory, and the like can be used in the conventional application.

When the new application management section 35 releases the resources 2013, the new application management section 35 sends an application termination notification 2015 to the conventional application management section 17. Thus, an image and sound can be provided to the user (2017).

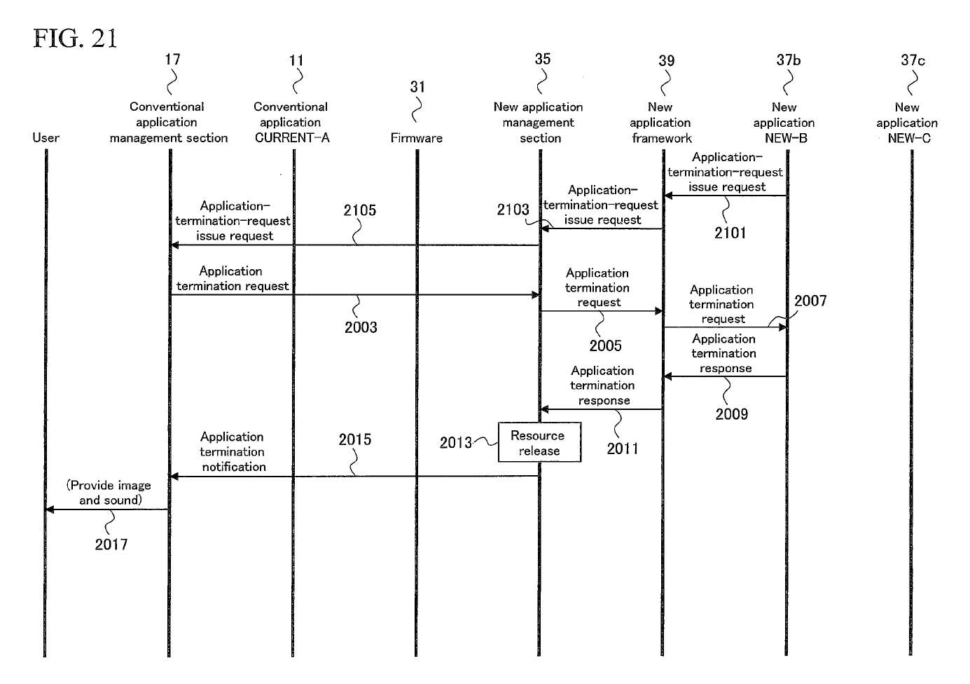

Next, the processing of spontaneous termination of a new application (an abnormal system) in the new application framework is described with reference to FIG. 21. A new application may be terminated irrespective of the intention of the user when an abnormality occurs in the new application, for example. When a spontaneous termination occurrence event arises, the new application NEW-B (37b) makes application-termination-request issue requests 2101, 2103 to the new application management section 35 via the new application framework 39, and the new application management section 35 makes an application-termination-request issue request 2105 to the conventional application management section 17. Thereafter, the termination processings are performed in a similar manner as an ordinary new application termination processing (2003-2017).

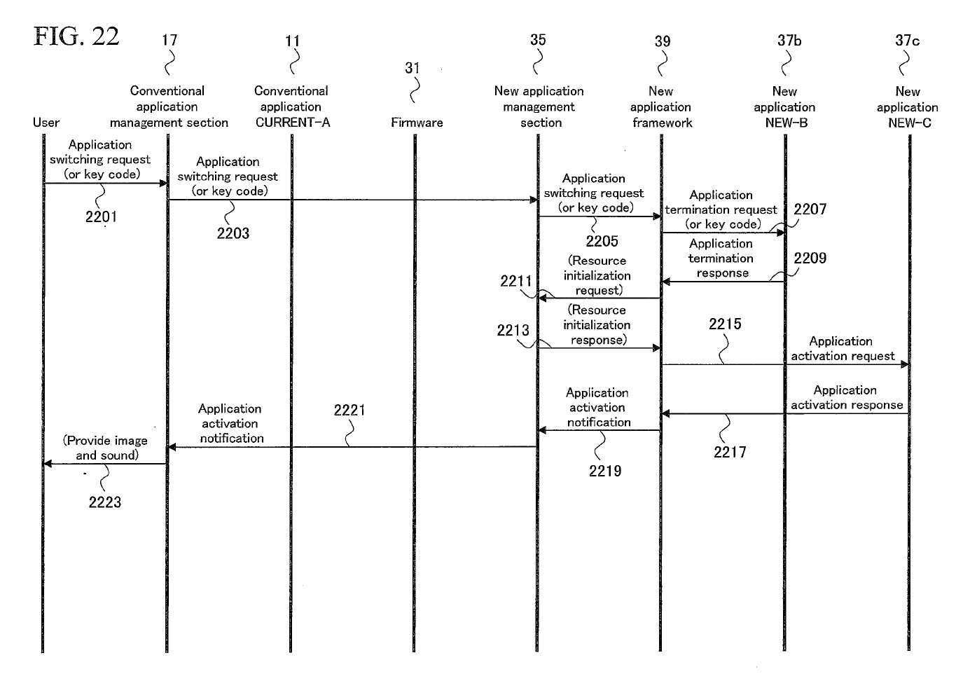

Next, a switching processing of new applications in the new application framework is described with reference to FIG. 22. Upon receipt of an application switching request 2201 from the user, the conventional application management section 17 makes an application switching request 2203 to the new application management section 35. Here, as described in the new application switching in a single process, application switching requests (2201, 2203, 2205, and 2207) may be simply events (key codes).

The new application management section 35 makes the application switching request 2205 to the new application framework 39. The new application framework 39 makes the application termination request 2207 to the new application NEW-B (37b).

The new application NEW-B (37b) stops the use of currently using resources, by performing termination of drawing, release of the working memory, and the like, and then notifies the new application framework 39 of an application termination response 2209.

The new application framework 39 performs the initialization of the resources (2211, 2213), if required, and makes an application activation request 2215 to the new application NEW-C (37c). When the activation of the new application NEW-C (37c) is completed, the new application NEW-C (37c) sends an activation response of the new application NEW-C (37c) to the new application management section 35 via the new application framework 39 (2217, 2219). The new application management section 35 sends a new application activation notification 2221 to the conventional application management section 17. The conventional application management section 17 can provide an image and sound to the user (2223).

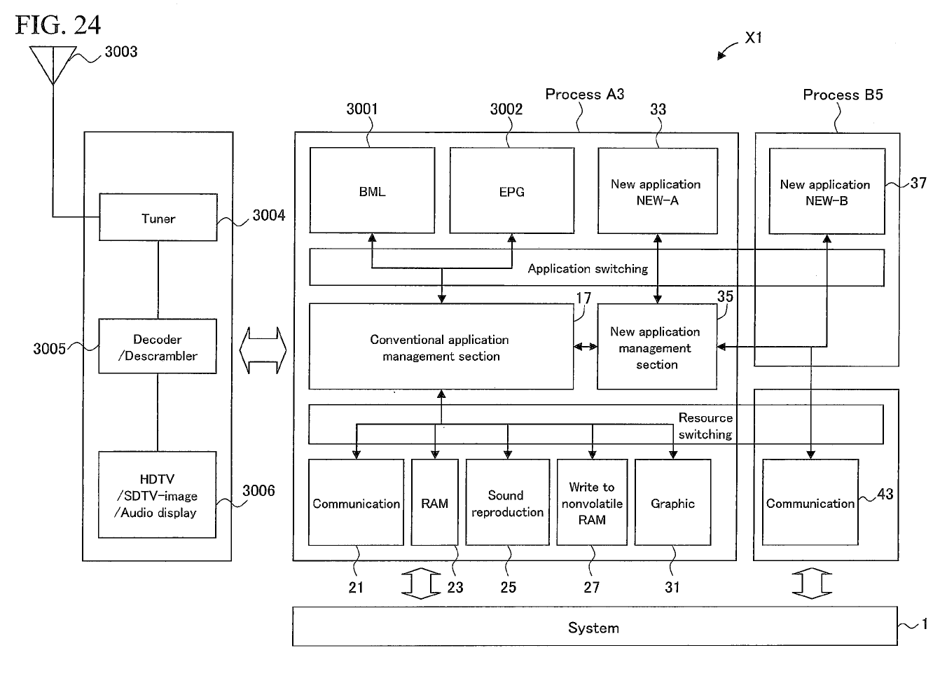

Next, examples in which the techniques according to the present embodiments described above are applied to specific apparatuses are described with reference to the accompanying drawings. FIG. 24 is a view showing a configuration example when the present embodiment is applied to a digital television receiver. FIG. 24 is the view showing the main configuration related to the digital television receiver X1, in addition to the basic configuration shown in FIG. 1. The same reference numerals are given to the components (on the right side of the view) described in FIG. 1, and the description thereof is omitted.

The configuration shown in FIG. 24 includes an antenna (3003), a tuner (3004), a decoder/descrambler (3005), and an HDTV/SDTV-image/audio display (3006) in addition to the components of FIG. 1.

A broadcast wave received by the antenna (3003) is extracted in the tuner (3004), and is subjected to demodulation/decode/MPEG2 DEMUX processings in the decoder/descrambler (3005). Thereafter image-decoding/audio-decoding is performed thereon, so that the image and sound can be audio-visually captured in the HDTV/SDTV-image/audio display (3006).

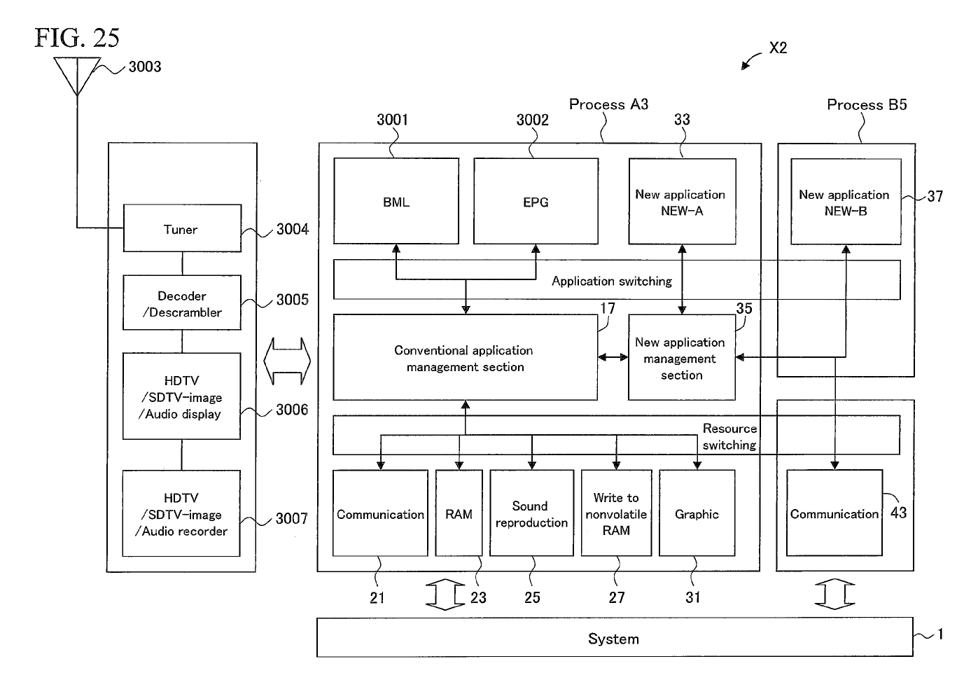

FIG. 25 is a view showing a configuration diagram when the techniques according to the above-described embodiments are applied to a recorder-reproducer, e.g., an HDD recorder X2, among the examples to which these techniques are specifically applied.

A broadcast wave received by the antenna (3003) is extracted in the tuner (3004), and is subjected to demodulation/decode/MPEG 2 DEMUX processings in the decoder/descrambler (3005). Thereafter image-decoding/audio-decoding is performed thereon, so that the image and sound can be audio-visually captured in the HDTV/SDTV-image/audio display (3006). Depending on the operation of the user, the resultant signal is recorded on a recording media, such as an HDD/DVD, in an HDTV/SDTV-image/audio recorder (3007).

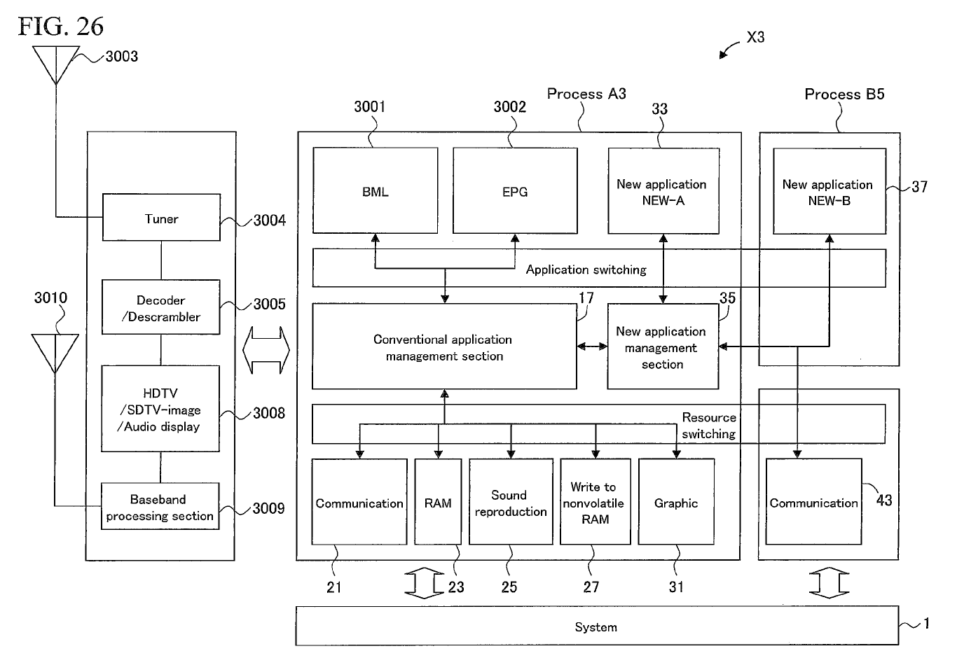

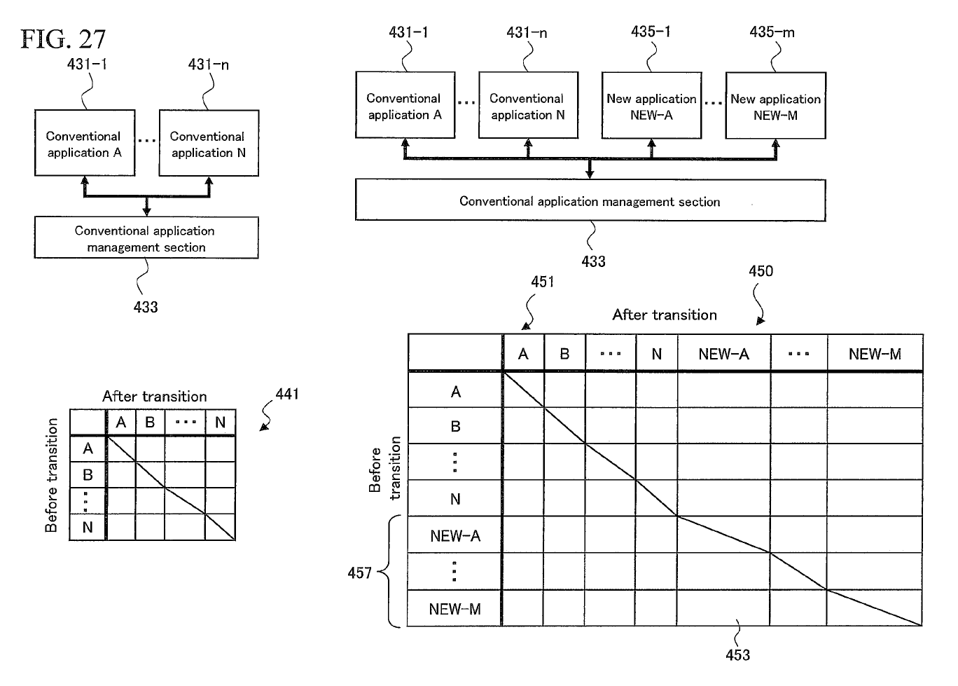

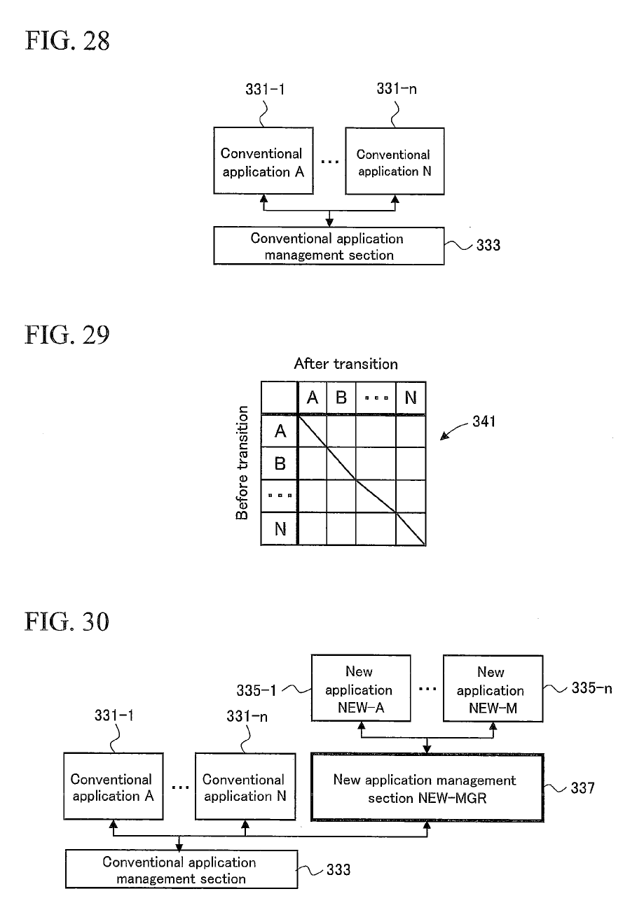

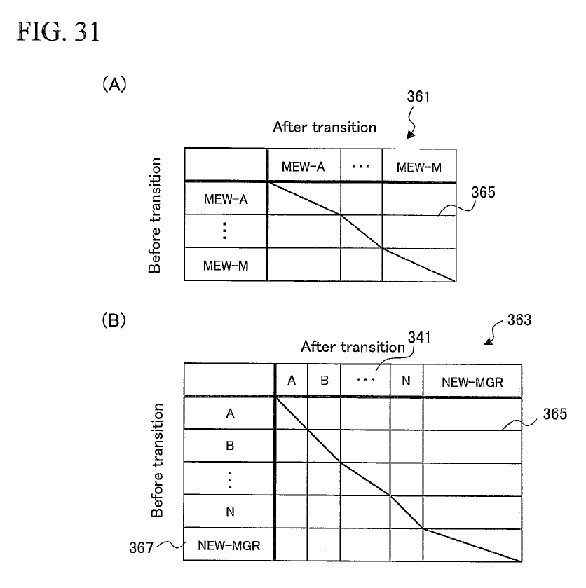

FIG. 26 is a view showing a configuration diagram when the techniques according to the above-described present embodiments are applied to a mobile terminal, e.g., a mobile phone X3 with a one-segment view function, among the examples to which these techniques are specifically applied. A broadcast wave received by the antenna (3003) is extracted in the tuner (3004), and is subjected to demodulation/decode/MPEG 2 DEMUX processings in the decoder/descrambler (3005). Thereafter image-decoding/audio-decoding is performed thereon, so that the image and sound can be audio-visually captured in a one-segment-image/audio display (3008).

The communication with a base station with regard to the mobile phone functions is performed in an antenna (3010) and a baseband processing section (3009).

In FIG. 24 to FIG. 26, the conventional application management section 17 performs the management, through a UI menu, on the channel selection of the tuner (3004), the start/stop of the decoder/descrambler (3005), the brightness adjustment/volume adjustment, and the like in the HDTV/SDTV-image/audio display (3006) or the one-segment-image/audio display (3008).

Here, a description is given of a case where the conventional applications are BML (data broadcasting: 3001) and EPG (electronic program guide: 3002).

BML is displayed during broadcast reception, but while activation of EPG, the conventional application management section (17) sets the BML in a non-display state to display the EPG.

In this case, resource switching between the graphic (31) and the RAM (23) occurs. That is, BML releases the graphic (31) and the RAM (23), and EPG newly acquires the right of using the graphic (31) and the RAM (23), so that an EPG screen is displayed. This switching processing is managed in the conventional application management section (17).

In switching from this state to the new application NEW-A (33), in other words, in switching the applications within a single Process A3, the resource switching occurs between the conventional application management section (17) and the new application management section (35).

That is, the conventional application management section (17) releases the graphic (31) and the RAM (23) which EPG is using, and notifies the new application management section (35) of the fact, and the new application management section (35) newly provides the right of using the graphic (31) and the RAM (23) to the new application NEW-A (33), so that the screen of NEW-A (33) is displayed.

Next, in switching an application between multiple processes, in other words, in switching to a new application NEW-B (37) of Process B5 which is a different process, resource switching for the graphic (31) and the RAM (23) occurs between different processes of the new application NEW-A (33) and new application NEW-B (37).

That is, the NEW-A (33) releases the graphic (31) and the RAM (23), and the new application management section (35) newly provides the right of using the graphic (31) and the RAM (23) to the NEW-B (37), so that the screen of NEW-B (37) is displayed.

On the other hand, in switching from this state to the new application NEW-A (33) of Process A3, the new application NEW-B (37) in Process B5 releases the graphic (31) and the RAM (23), and the new application management section (35) newly provides the right of using the graphic (31) and the RAM (23) to NEW-A (33), so that the screen of NEW-A (33) is displayed.

The switching processing between multiple processes is managed in the new application management section (35).

The conventional application management section (17) does not need to manage which of the new applications NEW-A (33) and the NEW-B (37) is using resources. Therefore, the new application management section (35) does not need to notify the conventional application management section (17) of a state where the new application management section (35) keeps using resources.

In further switching from this state to EPG (3002), the resource switching occurs again between the new application management section (35) and the conventional application management section (17). That is, the new application management section (35) releases the graphic (31) and the RAM (23) which the new application NEW-A (33) is using, and notifies the conventional application management section (17) of the fact. Then the conventional application management section (17) newly provides the right of using the graphic (31) and the RAM (23) to EPG (3002), so that the EPG screen is displayed.

In a series of application switching described above, the new application management section (35) does not need to control the units constituting a specific apparatus, the units including the antenna (3003), the tuner (3004), and the decoder/descrambler (3005) in FIG. 24 to FIG. 26, the HDTV/SDTV-image/audio display (3006) of FIGS. 24 and 25, the HDTV/SDTV-image/audio recorder (3007) of FIG. 25, the one-segment-image/audio display (3008), the baseband processing section (3009), and the antenna (3010) of FIG. 26, and the like. In other words, it is possible to control the apparatus without depending on the units constituting the apparatus. Accordingly, the present invention can be widely applied not only to the apparatuses shown above but to the apparatuses employing a system which runs with the same mechanism.

As described above, in the electronic apparatus according to the embodiments of the invention, a new application management section (resource management function) is added to perform the resource management between an existing conventional (common) application management section and itself as well as to perform the resource management between new applications. That is, by performing layered resource management between an existing application and a new application, the number of management items can be reduced as compared with a case where the management of the new application is also performed in the existing common application management section. Accordingly, an advantage arises that the stability of the electronic apparatus can be increased in operation.

Moreover, the function provided in an apparatus is split into a new application section, a common application section, and a system section in accordance with module decomposition, and the control on the hardware responsible for implementing the function which is essential according to a product category is performed in the common application section (conventional application management section). Thereby, in the hardware frequently modified in response to the technology advancement or a cost reduction request, the system section is separated from the influences at the time of the addition/modification of a function, and the stability thereof is improved.

In other words, the present invention has an advantage that the stability of the hardware can be improved since the common function which is essential to a product category is separated from the influences at the time of the addition of a new function which affects the added value of the product.

Moreover, the electronic apparatus according to the embodiments of the present invention has an advantage that the resource utilization and hardware control from a different process other than that of the common application become possible by adding a new application management section as well as a new application framework.

Thus, since module decomposition becomes possible, the functions provided in the apparatus are split into a new application section, a common application section, and a system section, while the control on the hardware responsible for implementing a essential function is performed according to the function featuring a product in the common application section (conventional application management section). Thereby, the stability is improved in the hardware frequently modified in response to the technology advancement or a cost reduction request, since the system section is separated from the influences at the time of the addition/modification of the function.

In other words, the common function which is essential to featuring a product can be separated from the influences at the time of the addition of a new function which affects the added value of the product, so that the stability of the hardware can be improved.

### INDUSTRIAL APPLICABILITY

The present invention is usable in electronic apparatuses.

1. An electronic apparatus provided with an operating system section capable of operating a plurality of applications, the electronic apparatus characterized by comprising:
an application management section serving as an application which manages at least one function of the electronic apparatus; and
a first new application management section serving as an application which manages a newly added function and shares information on a resource with the application management section.

2. The electronic apparatus according to claim 1, characterized in that the application management section and the first new application management section are included in a single process.

3. The electronic apparatus according to claim 1, characterized by further comprising
a second new application management section serving as an application which manages a new application section that is an application for implementing a newly added function, and which shares information on a resource with the first new application management section.

4. The electronic apparatus according to claim 1, characterized in that the first new application management section includes a proxy management function with which the first new application management section performs hardware control as a proxy of a different process by use of both a content of a processing desired to be executed and a parameter required for the processing.

5. The electronic apparatus according to claim 1, characterized in that the first new application management section includes an exclusive control section which performs exclusive control to avoid simultaneous access to certain hardware.

6. The electronic apparatus according to claim 1, characterized in that the first new application management section includes a resource management section which performs resource management of the hardware.

7. The electronic apparatus according to claim 1, characterized in that the first new application management section includes an API conversion section which performs interconversion between an API for the process of the first new application management section itself and an API for a different process (for a second new application).

8. The electronic apparatus according to claim 1, characterized in that the first new application management section includes an information notification function for address translation, which notifies the different process (the second new application) of information necessary for translating a virtual address to a physical address or a physical address to a virtual address.

9. The electronic apparatus according to claim 3, characterized in that the second new application management section includes exclusive control section which performs exclusive control to prevent a new application, which the second new application management section manages, from performing simultaneous access to certain hardware.

10. The electronic apparatus according to claim 4, characterized in that the proxy management function includes: a different-process communication section that communicates with the different process; the API conversion section; and the resource management section.

11. The electronic apparatus according to claim 1, characterized in that the application management section treats the first new application management section as belonging to a lower layer in resource management than its own layer.

12. The electronic apparatus according to claim 1, characterized in that the application management section performs management in such a way to regard, in the resource management, an addition of a new application in the first new application management section as only an addition of the first new application management section.

13. The electronic apparatus according to claim 1, characterized in that the application management section and the first new application management section are included in a single process.

14. The electronic apparatus according to claim 1, characterized by further comprising a second new application management section serving as an application which manages a new application section serving as an application for implementing a newly added function, and which shares information on a resource with the first new application management section.

15. The electronic apparatus according to claim 14, characterized in that the first new application management section performs resource management between the application management section and itself, and also performs resource management between the second new application management section and itself.

16. The electronic apparatus according to claim 1, characterized in that the second new application management section performs resource management between the first new application management section and itself, and also performs resource management between the new application and itself.

17. The electronic apparatus according to claim 14, characterized in that the first new application management section includes an exclusive control section which performs exclusive control to avoid simultaneous control on certain hardware.

18. The electronic apparatus according to claim 2, characterized by further comprising
a second new application management section serving as an application which manages a new application section that is an application for implementing a newly added function, and which shares information on a resource with the first new application management section.

19. The electronic apparatus according to claim 2, characterized in that the first new application management section includes a proxy management function with which the first new application management section performs hardware control as a proxy of a different process by use of both a content of a processing desired to be executed and a parameter required for the processing.

20. The electronic apparatus according to claim 3, characterized in that the first new application management section includes a proxy management function with which the first new application management section performs hardware control as a proxy of a different process by use of both a content of a processing desired to be executed and a parameter required for the processing.
